(19) United States
(12) Patent Application Publication
(10) Pub. No.: US 2014/0137973 A1
(43) Pub. Date: May 22, 2014

(54) CLOG RESISTANT FLUID PATHWAY

(71) Applicant: James L. Dickinson, Naugatuck, CT (US)

(72) Inventor: James L. Dickinson, Naugatuck, CT (US)

(73) Assignee: IDEX HEALTH & SCIENCE LLC, Bristol, CT (US)

(21) Appl. No.: 14/125,211

(22) PCT Filed: Jun. 14, 2011
(86) PCT No.: PCT/US2011/040296

§ 371 Date: Dec. 10, 2013

(51) Int. Cl. F16L 3/00

(52) U.S. Cl. CPC F16L 3/00
USPC 138/106; 29/428

(57) ABSTRACT

A clog resistant leak tight smooth transition fluid path directional turn in a fluid pathway that minimizes back pressure turbulence and fluid friction and is configured to be snakeable with a fish line or other wire product to clear or remove potential blockages due to particulate carried by fluid flowing in the fluid pathway is presented. In one example the transition fluid path is an insert having a predefined size and shape configured to be received in a complementary sized and shaped opening in the layer of a fluidic manifold. A leak tight communication passageway is defined by a groove following a smooth curved path located between a surface of the insert in facing relationship with a matching surface of the opening in the layer between the entry fluid path and the exit fluid path.

### FIELD OF THE INVENTION

The present invention relates generally to fluidic manifolds and deals more particularly with fluidic passageways in such fluidic manifolds and more specifically with clog resistant leak tight smooth turn fluid pathway transitions in such fluidic passageways. The present invention also more specifically deals with fluid pathway transitions in such fluidic passageways in fluidic manifolds that are serviceable or snakeable with a fishline or other wire product to clear out potential obstructions or clogs.

### BACKGROUND OF THE INVENTION

Fluidic manifolds are in common use in technologies requiring control of the flow of fluids in fields such as medical equipment, analytical equipment, industrial and research equipment and the like. A fluidic manifold may be defined as having one or more inlet and outlet ports that are internally connected in a maze of passageways, channels, and cavities to conduct the flow of fluids. A fluidic manifold may be populated with other fluid control, conditioning and sensing devices, such as for example valves, pumps, fittings, heaters, sensors, etc., to provide fluidic interconnections between the mounted components without the use of external tubing and hoses. A fluidic manifold may be comprised of one or more layers, and may be made of a suitable material for example, a polymer, aluminum, or other suitable material to carry out the intended function.

A schematic diagram of a single layer fluidic manifold representative of the prior art is shown in FIG. 1A and generally designated 10. Generally internal pathways for example 12, 14, 16, 18 are made by drilling intersecting holes, i.e., holes for pathways 12 and 14 intersect at a sharp turn for example a right angle 20; holes for pathways 12 and 16 intersect at a sharp turn for example a right angle 22; holes for pathways 16 and 18 intersect at a sharp turn or right angle 24 to make a fluidic circuit. The section of the hole not needed for pathway 12 is closed off by a plug 26 and the section of the hole not needed for the pathway 16 is closed off by a plug 28. Multilayer fluidic manifolds have been made by machining the various passageways, ports, channels, openings and conduits in one surface of a block of suitable material, and then attaching another block to that surface whereby the passageways are then located in the interior of the combined blocks. In some instances both halves of the combined blocks are machined or milled with mirror-image configurations in their mating surfaces which surfaces are brought together into intimate contact. It is essential that the contacting surfaces be leak tight, particularly if the module is to be used for conducting pressurized fluids. One method for joining solid pieces of a plastic polymer material is disclosed in U.S. Pat. Nos. 4,875,956, 4,999,069 and 5,041,181 the disclosures of which are incorporated herein by reference. A schematic diagram of a multilayer fluidic manifold representative of the prior art is shown in FIGS. 1B and 1C and generally designated 30 and comprises layers 32, 34 and 36. A hole 38 is drilled in layer 32 and intersects at a sharp turn for example a right angle 40 with a pathway 42 made from a track milled in the surface 46 of layer 34 between layers 32 and 34 to transition from the surface 44 of layer 32 to the surface 46 of layer 34. A hole 48 is drilled in layer 34 and intersects at a sharp turn for example a right angle 50 with the pathway 42 between layers 32 and 34 and at a sharp turn for example a right angle 52 with a pathway 54 made from a track milled in the in the surface 56 of layer 36 between layers 34 and 36 to transition from the surface 46 of layer 34 to the surface 56 of layer 36. Although FIGS. 1B and 1C show a track milled in one surface of a layer, mirrored tracks can be milled in facing surfaces of adjacent layers to form the fluid pathway.

Sharp turn for example right angle transitions as illustrated for example in FIG. 1D and sharp corner angular transitions as illustrated for example in FIG. 1E and FIG. 1F in fluid passageways in fluidic manifolds, particularly transitions between layers, tend to accumulate particulate carried by fluid flowing in the fluid passageway at the outside sharp corner 70 of the right angle transition in the fluid passageway in FIG. 1D or the outside sharp corner 74 of the angular transition in the fluid passageway in FIG. 1E. The accumulation of such particulate form blockages or obstructions in the fluidic passageway and are difficult to clear and in many instances are not field serviceable by snaking a fish line or other wire product through the sharp turn or sharp corner angular transition in the fluid passageway thus limiting the useful life of the fluidic manifold. A sharp turn transition or sharp corner angular transition may trap gas bubbles, or may cause unwanted dispersion (fluid mixing). Sharp turn transition of fluid flow around an inner sharp corner 72 in the fluid passageway in FIG. 1D or the inner sharp corner 76 of the angular transition of fluid flow in fluidic passageway in FIG. 1E also tend to cause increased fluid turbulence, back pressure and fluid friction as fluid flows through the fluid passageway.

What is needed therefore is a way to provide a transition fluid passageway in a fluidic manifold that overcomes the drawbacks and disadvantages of sharp turn transition and sharp corner angular transition in fluid passageways in fluidic manifolds.

### SUMMARY OF SOME EXAMPLES OF THE INVENTION

The present invention provides a technical solution to the problems caused by sharp turn and sharp corner transition fluid passageways in fluid pathways in a fluidic manifold. The present invention provides a clog resistant leak tight smooth transition fluid path directional turn in a fluid pathway that minimizes back pressure turbulence and fluid friction and is configured to be snakeable with a fish line or other wire product to clear or remove potential blockages due to particulate carried by fluid flowing in the fluid pathway.

In a broad aspect of the invention a fluidic module includes a body having one or more layers having a width, height and length dimension, a first major face surface and an oppositely disposed second major face surface, a fluid pathway comprising an entry fluid path and an exit fluid path, and a transition fluid path arranged and configured to provide a smooth directional turn between the entry fluid path and the exit fluid path.

In some embodiments the transition fluid path is an insert having a predefined size and shape configured to be received in a complementary sized and shaped opening in the layer to provide a leak tight communication passageway between the entry fluid path and the exit fluid path.

In some embodiments the transition fluid path is a leak tight passageway defined between a surface of the insert in facing relationship with a matching surface of the opening in the layer.

In some embodiments the entry fluid path is arranged on one of the first major face surface and the second major face surface, and the exit fluid path arranged on the other of the first major face surface and the second major face surface.

In some embodiments the insert is a cylindrical insert having a cylindrical outer peripheral wall and the opening is a cylindrical opening having a circumferential wall surface wherein the leak tight passageway is a groove inscribed in the cylindrical insert outer peripheral wall along a curved path and closed off by the cylindrical opening circumferential wall surface.

In some embodiments the insert is a cylindrical insert having a cylindrical outer peripheral wall and the opening is a cylindrical opening having a circumferential wall surface wherein the leak tight passageway is a groove inscribed in the cylindrical opening circumferential wall surface along a curved path and is closed off by the cylindrical insert outer peripheral wall surface.

In some embodiments the insert is a cylindrical insert split lengthwise wherein the leak tight passageway is a groove following a curved path inscribed in a lengthwise face surface in at least one split half of the cylindrical insert and is closed off by a lengthwise face surface of the other split half of the cylindrical insert.

In some embodiments the leak tight passageway is a groove following a curved path inscribed in the lengthwise face surface in one split half of the cylindrical insert and is closed off by a mirror image groove inscribed in the lengthwise face surface of the other split half of the cylindrical insert.

In some embodiments the insert is a cylindrical insert configured with at least one fluid conduit extending through the cylindrical insert between points on the circumferential wall surface to provide the leak tight passageway at a desired angle between the entry fluid path and the exit fluid path.

In some embodiments the insert is a stack of cylindrical inserts made up of any number of cylindrical inserts including an angled fluid path cylindrical insert and a straight fluid path cylindrical insert and rotatable with respect to one another to provide the leak tight passageway between the entry fluid path and the exit fluid path.

In some embodiments the angled fluid path cylindrical insert and the straight fluid path cylindrical insert are configured with castellations for cooperative engagement with castellations on an adjacent angled fluid path cylindrical insert and a straight fluid path cylindrical insert to maintain a relative alignment of the cylindrical inserts in a stack of inserts.

In some embodiments one of the entry fluid path and the exit fluid path is configured to lie in a first plane of a layer and the other of the entry fluid path and the exit fluid path is configured to be in a direction substantially perpendicular to the first plane of the layer. A cavity has an outer facing shoulder surface in which one end of the entry fluid path is arranged to terminate at one side of the outer facing shoulder surface and one end of the exit fluid path is arranged to terminate at an end opposite the one side of the outer facing shoulder surface. The insert is configured to provide an inner facing “ski jump” curved surface mirroring the cavity outer facing shoulder surface wherein the leak tight passageway is a groove inscribed in the insert inner facing “ski jump” curved surface and is closed off by the cavity shoulder surface.

In some embodiments the leak tight passageway is a groove inscribed in the cavity shoulder surface and mirrors the groove inscribed in the insert inner facing “ski jump” curved surface.

In some embodiments one of the entry fluid path and the exit fluid path is configured to lie in a first plane of a layer and the other of the entry fluid path and the exit fluid path is configured to be in a direction substantially perpendicular to the first plane of the layer. The layer has a cavity configured with an outer facing concave surface. One end of the entry fluid path is arranged to terminate at one side of the outer facing concave surface and one end of the exit fluid path is arranged to terminate at an end opposite the one side of the outer facing concave surface. The insert is configured to provide an inner facing “ski jump” convex surface mirroring the cavity outer facing concave surface wherein the leak tight passageway is a groove inscribed in the insert inner facing “ski jump” convex surface and is closed off by the cavity outer facing concave surface.

In some embodiments the leak tight passageway is a groove inscribed in the cavity outer facing concave surface and mirrors the groove inscribed in the insert inner facing “ski jump” convex surface.

In some embodiments one of the entry fluid path and the exit fluid path is configured to lie in a first plane of a layer and the other of the entry fluid path and the exit fluid path is configured to be in a direction substantially perpendicular to the first plane of the layer. The layer has a cavity and one end of the entry fluid path is arranged to terminate at a desired location along a peripheral wall of the cavity and one end of the exit fluid path is arranged to terminate at the desired location along the peripheral wall of the cavity in a direction substantially perpendicular to the one end of the entry fluid path. The insert is arranged with an inner facing curved elbow surface in communication with the one end of the entry fluid path and the one end of the exit fluid path to provide the leak tight passageway between the entry fluid path and the exit fluid path.

In some embodiments the entry fluid path is arranged at a first desired angle between the first major face surface and said second major face surface of a first layer, and the exit fluid path is arranged at a second desired angle between the first major face surface and the second major face surface of a second layer. The transition fluid path is a hole through a third layer sandwiched between the first layer and the third layer and is configured to intersect between one end of the entry fluid path and one end of the exit fluid path to provide a leak tight communication passageway at a desired angle between the entry fluid path and the exit fluid path.

In some embodiments the transition fluid path has one end of the exit fluid path configured as a funnel and arranged normal to and in intersecting contact with one end of the entry fluid path to provide a leak tight communication between the entry fluid path and the exit fluid path.

In some embodiments the insert is a cylindrical insert having a cylindrical outer peripheral wall and a groove inscribed in the cylindrical insert outer peripheral wall following along a curved path and the opening is a cylindrical opening having a circumferential wall surface and a groove mirroring the groove inscribed in the cylindrical insert outer peripheral wall inscribed in the cylindrical opening circumferential wall surface wherein the groove in the cylindrical insert and the groove in the cylindrical opening close off one another to create the leak tight passageway.

In a further broad aspect the invention concerns a method including the steps of creating a fluid pathway having an entry fluid path, an exit fluid path, and a transition fluid path; arranging the transition fluid path to follow along a smooth curve between an end of the entry fluid path and the end of the exit fluid path; connecting one end of the entry fluid path to one end of the transition fluid path; and, connecting one end of the exit fluid path to an opposite end of the transition fluid path to provide a leak tight clog resistant transition fluid path between the entry fluid path and the exit fluid path.

In some embodiments the method includes creating the leak tight transition fluid path between an outer facing surface of an insert and an oppositely disposed matching face surface of an opening configured to receive the insert; forming a groove in at least one of the outer facing surface of the insert and the oppositely disposed matching face surface of the opening; receiving the insert in the opening; closing off the groove with the at least one of the outer facing surface of the insert and the oppositely disposed matching face surface of the opening when the insert is received in the opening to form the leak tight transition fluid path between the entry fluid path and the exit fluid path.

In a further broad aspect the invention concerns a plug having a predefined size and shape and configured to be received in a complementary sized and shaped opening in a layer of the fluidic manifold, and includes a groove inscribed in a peripheral wall surface of the plug and following along a smooth curved path and defining a transition fluid path between the peripheral wall surface of the plug and a facing surface of the opening when the plug is received in the opening in the layer of the fluidic manifold.

### BRIEF DESCRIPTION OF THE DRAWINGS

Other features, advantages and benefits of the present invention will become readily apparent from the following description taken in conjunction with the drawings wherein:

FIG. 1A is a schematic diagram of a single layer fluidic manifold representative of the prior art.

FIG. 1B is a schematic diagram of a multilayer fluidic manifold representative of the prior art.

FIG. 1C is an enlarged view of a sharp right angle transition between fluid pathways of the prior art.

FIG. 2A is a schematic diagram exploded view of a fluidic manifold showing an example of the transition fluid passageway formed between the outer peripheral wall surface of the plug and the inner peripheral wall surface of a hole in a middle layer of the fluidic manifold.

FIG. 2B is a schematic diagram partial view of the fluidic manifold of FIG. 2A showing an example of the transition fluid passageway formed by a groove in the inner peripheral wall surface of the hole in the middle layer and closed off by the outer peripheral wall surface of the plug when received in the hole.

FIG. 2C is an enlarged schematic view of the hole in the middle layer showing the groove in the inner peripheral wall surface of the hole.

FIG. 2D is a schematic diagram partial view of the fluidic manifold of FIG. 2A showing an example of a leak tight transition fluid passageway formed by a groove in the outer peripheral wall surface of a plug and closed off the outer peripheral wall surface of the hole when the plug is received in the hole.

FIG. 2E is an enlarged schematic view of a plug showing a groove following a spiral curved path in the outer peripheral wall surface of the plug.

FIG. 2F is a schematic diagram partial view of the fluidic manifold of FIG. 2A showing an example of a leak tight transition fluid passageway formed by a spiral groove in the inner peripheral wall surface of the hole in the middle layer and closed off by a mirrored spiral groove in the outer peripheral wall surface of the plug when the plug is received in the hole.

FIG. 2G is an enlarged schematic view showing the leak tight transition fluid passageway formed by the mirrored grooves on the outer peripheral wall surface of the plug and the inner peripheral wall surface of the hole in the middle layer.

FIG. 2H is a schematic diagram view of a keyed plug showing a groove following a curved path from one end of the plug to an opposite end of the plug and a groove following a curved path along the perimeter an end face surface of the plug.

FIG. 2I is a partial schematic view of a fluid pathway in a fluidic manifold showing a vertical-to-horizontal leak tight transition fluid passageway employing the plug illustrated in FIG. 2H.

FIG. 2J is a partial schematic view of a fluid pathway in a fluidic manifold showing a leak tight fluid transition between fluid pathways located on or near a surface of a layer of a fluidic manifold.

FIG. 3A is a schematic diagram of a plug split lengthwise with its respective inner facing surface having a groove following an “S”-shaped curved path to create a leak tight transition fluid path when the split halves of the plug are joined together.

FIG. 3B is a schematic diagram of a plug split lengthwise with its respective inner facing surface having a groove following an “J”-shaped curved path to create a leak tight transition fluid path when the split halves of the plug are joined together.

FIG. 3C is a schematic diagram of a plug split lengthwise with its respective inner facing surface having a groove following a “P”-shaped curved path to create a leak tight transition fluid path when the split halves of the plug are joined together.

FIG. 3D is a schematic diagram of a fluidic manifold employing the leak tight fluid transition passageways of the split plugs of FIGS. 3A-3C to form a desired fluid pathway.

FIG. 4A is a schematic view of an example of a fluidic manifold employing a stack of angled hole inserts and straight hole inserts to form a leak tight fluid transition passageway between two fluid pathways in the fluidic manifold.

FIG. 4B is a schematic top view of a major face surface of the sandwiched layer of the fluidic manifold shown in FIG. 4A.

FIG. 4C is an exploded schematic view of a portion of the fluidic manifold shown in FIG. 4a showing the stack of angled hole inserts and straight hole inserts in alignment with the hole in the sandwiched layer between two closing layers.

FIG. 5 is an enlarged view of a stack of angled hole inserts and straight hole inserts having castellations on facing surfaces to maintain relative angles and alignment with respect to one another to create a leak tight transition fluid pathway.

FIG. 6A is a schematic diagram of an example of a fluidic manifold showing a leak tight transition fluid pathway created using an angled hole plug.

FIG. 6B is an enlarged schematic view of an angled hole plug.

FIG. 6C is a fragmentary enlarged schematic view of the hole in the middle layer of the fluidic manifold of FIG. 6A arranged to receive the angled plug shown I FIG. 6B.

FIGS. 6D and 6E are schematic diagram views of alternate examples of an angled hole plug.

FIGS. 7A and 7B are schematic diagram views of an example of a concave configured “ski jump” plug.

FIGS. 7C and 7D are schematic diagram views of a fluidic manifold showing an example of a leak tight transition fluid pathway created using the concave configured “ski jump” plugs shown in FIGS. 7A and 7B.

FIG. 7E is an enlarged schematic view of a pocket in a major face surface of a layer of a fluidic manifold arranged to receive the concave configured “ski jump” plug shown in FIGS. 7A and 7B.

FIG. 7F is an enlarged schematic view of a leak tight transition fluid pathway created using two concave configured “ski jump” plugs as shown in FIGS. 7A and 7B.

FIG. 8A is a schematic diagram view of an example of a convex configured “ski jump” plug.

FIG. 8B is an enlarged schematic view of a pocket in a major face surface of a layer of a fluidic manifold arranged to receive the convex configured “ski jump” plug shown in FIG. 8A.

FIG. 8C is a schematic diagram of an example of a fluidic manifold showing a leak tight transition fluid pathway created using the convex configured “ski jump” plug shown in FIG. 8A.

FIG. 8D is a cross-section schematic view of the fluidic manifold taken along the lines 8D-8D in FIG. 8C showing the convex configured “ski jump” plug received in the pocket in the major face surface of the layer of the fluidic manifold.

FIG. 9A is an enlarged schematic view of an example of an elbow plug.

FIG. 9B is an enlarged schematic view of a pocket in a face surface of a layer of a fluidic manifold arranged to receive the elbow plug shown in FIG. 9A.

FIGS. 9C and 9D are schematic diagrams of an example of a fluidic manifold configured with a leak tight transition fluid pathway created using the elbow plugs shown in FIG. 9A.

FIG. 10A is an enlarged schematic view of an example of a perimeter grooved “pillow-like” plug.

FIG. 10B is a schematic diagram view of an example of a fluidic manifold configured with a leak tight transition fluid pathway created using the “pillow-like” plug of FIG. 10A.

FIG. 10C is a schematic top plan partial view showing a tubular leak tight transition fluid pathway created with a groove in the surface of the receiving pocket mirroring the groove in the perimeter surface of the “pillow-like” plug.

FIG. 11A is an enlarged schematic view of an example of a side face surface grooved plug.

FIG. 11B is a schematic diagram view of an example of a fluidic manifold configured with a leak tight transition fluid pathway created using the side face surface grooved plug of FIG. 11A.

FIG. 12A is an enlarged schematic view of an example of a leak tight transition fluid pathway created in a molded plug.

FIG. 12B is a schematic diagram view of an example of a fluidic manifold configured with a leak tight transition fluid pathway created in the molded plug of FIG. 12A.

FIG. 13A is a schematic diagram view of an example of a fluidic manifold configured with a leak tight transition fluid pathway created with angled hole layers.

FIG. 13B is an enlarged schematic fragmentary cross-section view of the leak tight transition fluid pathway shown in the fluidic manifold of FIG. 13A.

FIG. 14A is a schematic diagram view of an example of a fluidic manifold configured with a machined leak tight funnel transition fluid pathway.

FIG. 14B is an enlarged schematic fragmentary cross-section view of the machined leak tight funnel transition fluid pathway shown in the fluidic manifold of FIG. 14A.

FIG. 15A is a schematic diagram view of an example of a fluidic manifold configured with a machined tangential localized enlargement leak tight swirling fluid flow transition fluid pathway.

FIG. 15B is an enlarged schematic fragmentary top view of the machined tangential localized enlargement leak tight swirling fluid flow transition fluid pathway shown in the fluidic manifold of FIG. 15A.

FIG. 16A is a schematic diagram view of an example of a fluidic manifold configured with a machined dimpled angled end leak tight transition fluid pathway.

FIG. 16B is an enlarged schematic fragmentary view cross-section view of the machined dimpled angled end leak tight transition fluid pathway shown in the fluidic manifold of FIG. 16A.

FIG. 17A is a schematic diagram view of an example of a fluidic manifold configured with a machined localized enlargement leak tight transition fluid pathway.

FIG. 17B is an enlarged schematic fragmentary top view of the machined localized leak tight transition fluid pathway shown in the fluidic manifold of FIG. 17A.

FIG. 18A is a schematic diagram view of an example of a fluidic manifold configured with a machined plunge leak tight transition fluid pathway.

FIG. 18B is an enlarged schematic fragmentary cross-section view of the machined plunge leak tight transition fluid pathway shown in the fluidic manifold of FIG. 18A.

FIG. 19A is a schematic diagram view of an example of a fluidic manifold configured with an over-molded pre-formed elbow plug to create a non-right angle leak tight transition fluid pathway.

FIG. 19B is an enlarged schematic view of an example of an over-molded pre-formed elbow plug.

FIG. 20A is a schematic view of an example of a fluidic manifold configured with an over-molded pre-formed “S” plug to create a non-right angle leak tight transition fluid pathway.

FIG. 20B is an enlarged schematic view of an example of an over-molded pre-formed “S” plug.

FIG. 21 is a schematic diagram showing a fishline fed through an example of a leak tight transition fluid pathway to clear potential clogs that may occur from particulate carried by fluid flowing in the fluid pathway.

FIG. 22 is a flowchart showing the steps of the basic method of the present invention.

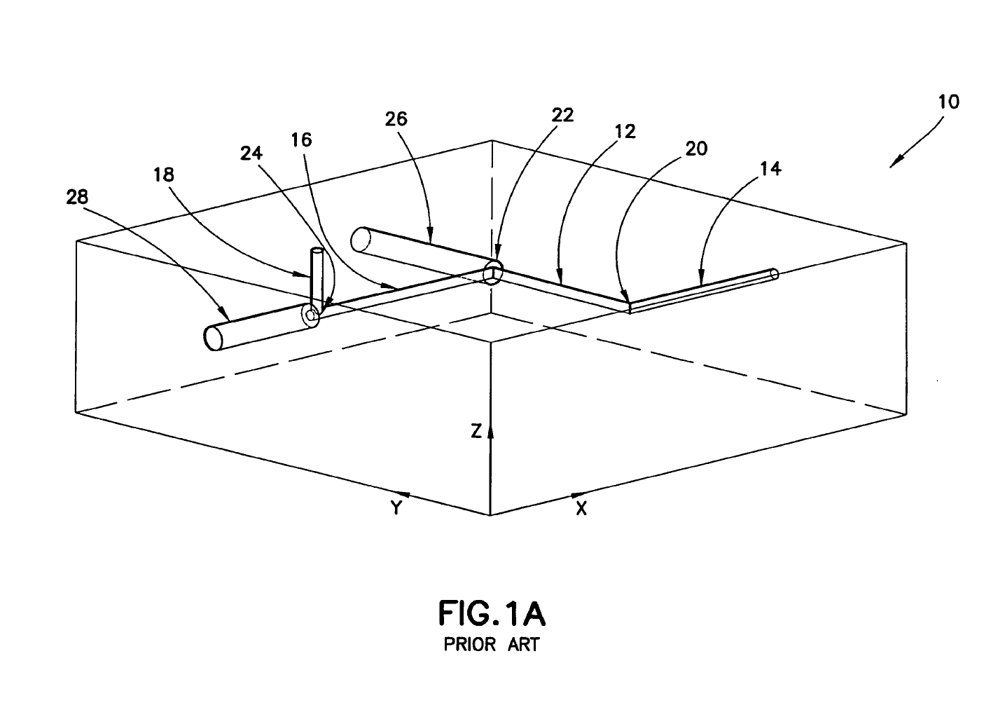

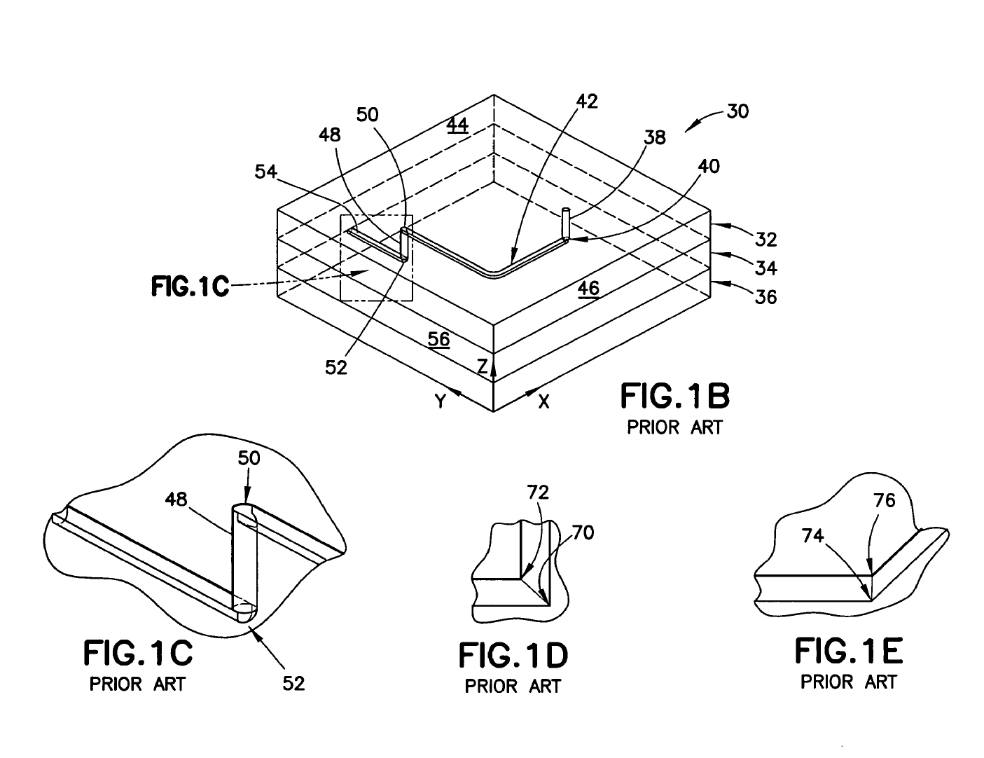

### DESCRIPTION OF EXAMPLES OF THE INVENTION

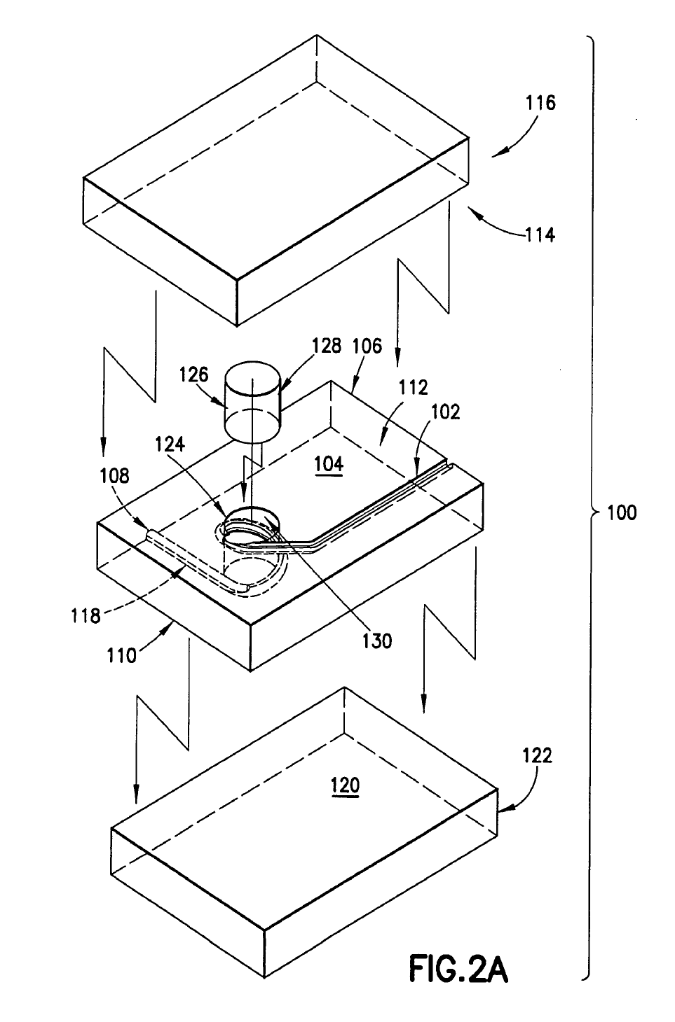

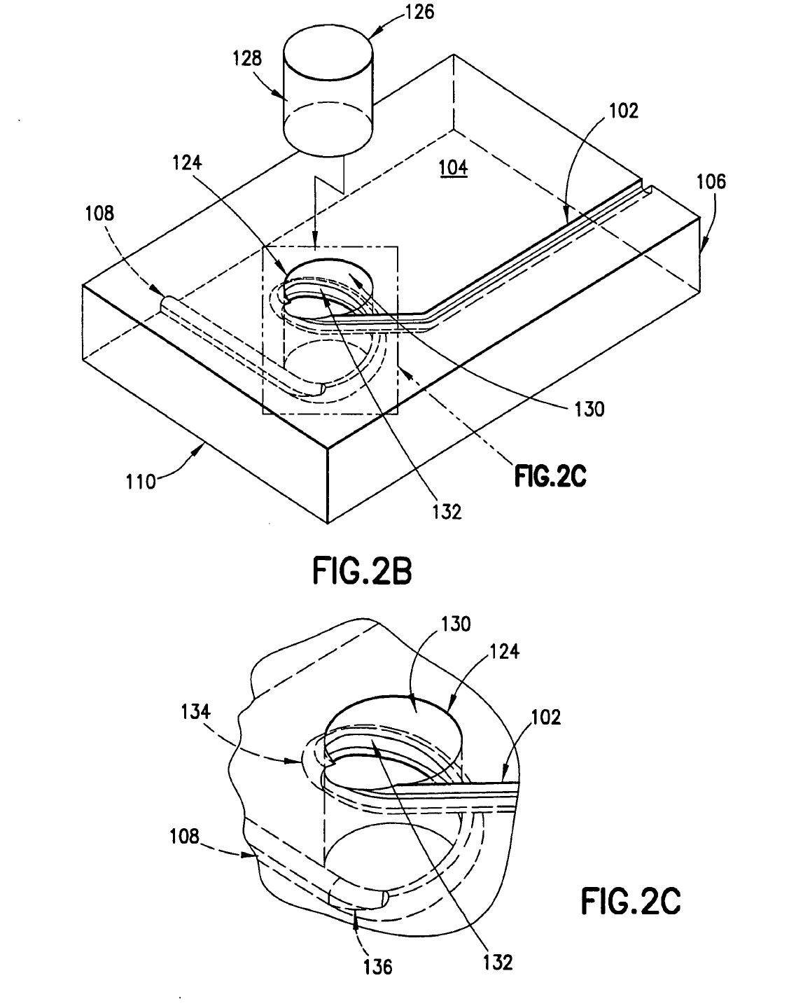

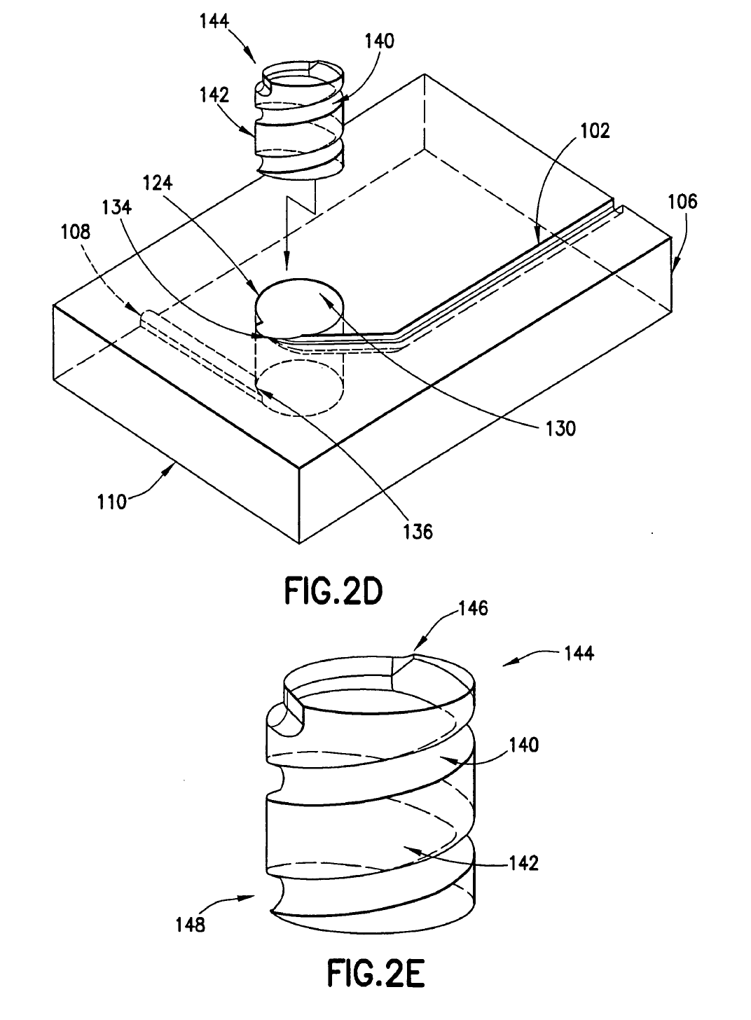

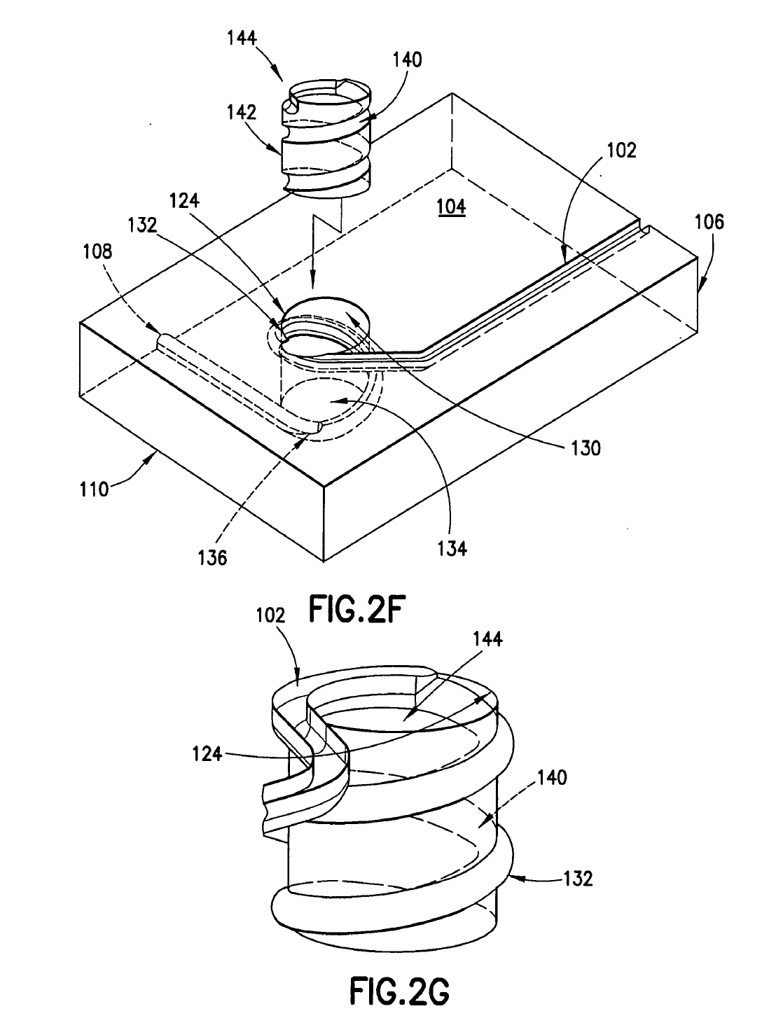

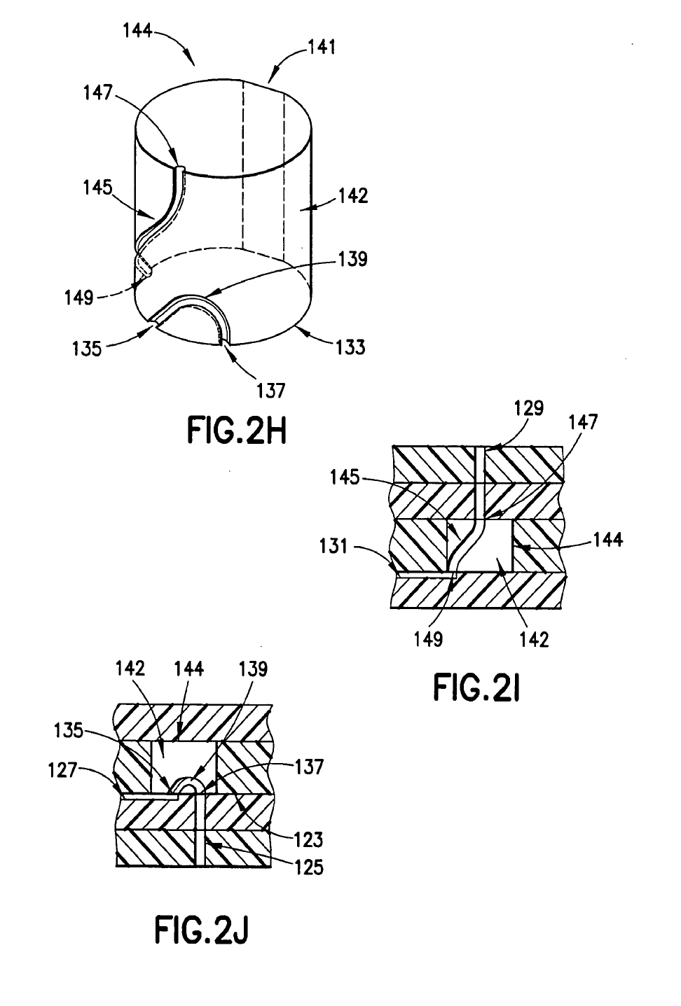

With reference to FIG. 2A a schematic diagram of a fluidic manifold having a smooth fluid transition passageway to provide a smooth clog resistant leak tight transition fluid passageway between fluid passageways on oppositely disposed major face surfaces in a layer in the fluidic manifold is shown in an example of the invention and is generally designated 100. In one example, the invention contemplates the diameter of a fluid passageway to be typically in the range of about 0.020 inches to 0.375 inches although not limited thereto and may be in the microfluidic diameter range. The fluidic manifold may be a single layer or multilayer fluidic manifold and of a material such as for example, a polymer plastic, aluminum or any other material suitable to carry out the function of the manifold. In this example, a groove or track 102 is machined or milled in the upwardly facing major face surface 104 of the layer 106 and a groove or track 108 is machined or milled in the downwardly facing major face surface 110 oppositely disposed the upwardly facing major surface 104. The groove or track and other milling or machining of turns, radii, or shaping may be formed using computer numerical control (CNC) apparatus and suitably shaped drill bits, router bits, and the like and well known to those in the art to machine or mill the surfaces or drill into or through a layer or layers of a fluidic manifold. A fluid passageway may be tubular, “C”-shaped, “D”-shaped, square, rectangular or other suitable shape to carry out the intended function.

In this exemplary embodiment a fluid passageway generally designated 112 is formed by closing off the groove 102 with the face 114 of a layer 116 in intimate contact with the upwardly facing major surface 104. A fluid passageway generally designated 118 is formed by closing off the groove 108 with the face 120 of a layer 122 in intimate contact with the downwardly facing major surface 110. A hole or opening generally designated 124 is machined or milled through the layer 106 between the upwardly and downwardly facing surfaces 104 and 110 respectively of the layer 106. An insert or plug generally designated 126 is configured to be sized and shaped to be received and held in the hole or opening 124 in the layer 106. As described in further detail herein below, a transition fluid passageway is formed between the outer peripheral wall surface 128 of the insert or plug 126 and the inner peripheral wall surface 130 of the hole 124.

In some embodiments, a groove or track 132 is machined or milled in the inner peripheral wall surface 130 of the hole 124 in the layer 106 and is shown in a schematic diagram in FIGS. 2B and 2C to follow a smooth curved circumferential path or spiral such that the groove 132 at one end 134 of the hole 124 is arranged to intercept the track 102 terminating in the peripheral wall surface 130 at the one end 134 of the hole 124 and the opposite end 136 of the hole 124 with the track 108 terminating at the inner peripheral wall surface 130 at the opposite end 136 of the hole 124 such that when the insert or plug 126 is received in the hole 124 the outer peripheral wall surface 128 of the plug 126 closes off the groove 132 in the inner peripheral wall surface 130 of the hole 124 to form a leak tight transition fluid passageway between the two tracks 102 and 108 on the opposite major face surfaces 104 and 110 respectively of the layer 106.

In some embodiments, a groove or track 140 is machined or milled in the outer peripheral wall surface 142 of an insert or plug generally designated 144 and is shown in a schematic diagram in FIGS. 2D and 2E to follow a smooth curved circumferential path or spiral such that the groove 140 at one end 146 of the plug 144 is arranged to intercept the track 102 terminating in the peripheral wall surface 130 at one end 134 of the hole 124 and at the opposite end 148 of the plug 144 with the track 108 terminating in the peripheral wall surface 130 at the opposite end 136 of the hole 124 such that when the insert or plug 144 is received in the hole 124, the inner wall surface 130 of the hole 124 closes off the groove 140 in the outer peripheral wall surface 142 of the plug 144 to form a leak tight transition fluid passageway between the two tracks 102, 108 on the opposite major face surfaces 104 and 110 respectively of the layer 106.

In some embodiments, a groove 140 is machined or milled in the outer peripheral wall surface 142 of the plug 144 and a groove 132 mirroring the groove 140, or visa-versa, is machined or milled in the outer peripheral wall surface 130 of the hole 124 as shown in a schematic diagram in FIG. 2F and 2G to follow a smooth curved circumferential path or spiral such that the groove 132 in the outer peripheral wall surface 142 of the insert or plug 144 and the inner peripheral wall surface 130 of the hole 124 close off one another (as best viewed in FIG. 2G) are arranged to intercept the track 102 terminating in the peripheral wall surface 130 at one end 134 of the hole 124 and at the opposite end 148 of the plug 144 with the track 108 terminating in the peripheral wall surface 130 at the opposite end 136 of the hole 124 such that when the insert or plug 144 is received in the hole 124 a tubular shaped transition fluid passageway is formed between the two tracks 102, 108 on the opposite major face surfaces 104 and 110 respectively of the layer 106.

The pitch of the spiral groove may be constant or variable dependent on the particular application. In some embodiments of the invention, the fluid passageways formed on the major face surfaces of the layer intersect tangentially with the transition fluid passageway formed between the outer peripheral wall surface of the plug and the outer peripheral wall surface of the hole to minimize fluid back pressure turbulence and fluid friction in addition to being cleanable by a “fish line” or other wire product that is fed through the fluid pathway.

In some embodiments the plug is cylindrically shaped and has a slightly larger diameter than the diameter of the hole to force a compressive load on the plug during the bonding process which causes the plug to expand to create a leak tight transition fluid passageway when the plug is received in a hole or cavity in a layer.

In some embodiments the length dimension of the plug is longer than the thickness dimension of a corresponding layer in which the plug is received to force a compressive load on the plug during the bonding process which causes the plug to expand to create a leak tight transition fluid passageway when the plug is received in a hole or cavity in the layer.

In some embodiments, the insert or plug may be bonded by diffusion or chemical bonding in the hole to form a leak tight or fluid tight transition passageway. In some embodiments, the insert or plug may be of a shape other than a cylinder to accommodate a specific design or requirement and may be for example, hexagonal, rectangular, pentagonal or oblong shaped. In some embodiments the insert or plug and hole may be keyed for example as shown in FIG. 2H to assist in alignment between the plug and hole during the assembly of the manifold. In the example shown in FIG. 2H a portion 141 of the outer peripheral wall surface 142 of the insert or plug 144 is flattened so that the insert or plug 144 is keyed and can only be received in a hole in a layer having a similar lengthwise flattened peripheral wall portion.

The insert or plug 144 illustrated in FIG. 2H is additionally shown for purposes of example in FIG. 2I with a groove 145 in the peripheral wall 142 following a curved path from an upper end 147 to a lower end 149 to provide a leak tight fluid transition path between fluid pathways 129 and 131 respectively located on oppositely disposed major face surfaces of a layer, and is particularly useful in providing a vertical-to-horizontal transition.

The insert or plug 144 illustrated in FIG. 2H is additionally shown for purposes of example in FIG. 2J with a groove 139 in the peripheral wall 142 following a curved path from one end 137 at the perimeter 133 of the plug to an opposite end 135 also at the perimeter 133 of the plug to create a leak tight fluid transition path between fluid pathways 125 and 127 respectively located on or near a surface 123 of a layer and a fluid pathway 127 located on a major face surface of the layer. It will be recognized and understood that an insert or plug having either of the grooves 145, 139 is not limited to a keyed insert or plug.

In some embodiments, the insert or plug and layer or layers of the fluidic manifold including the hole and grooves or tracks may be formed using injection molding techniques known to those skilled in the art.

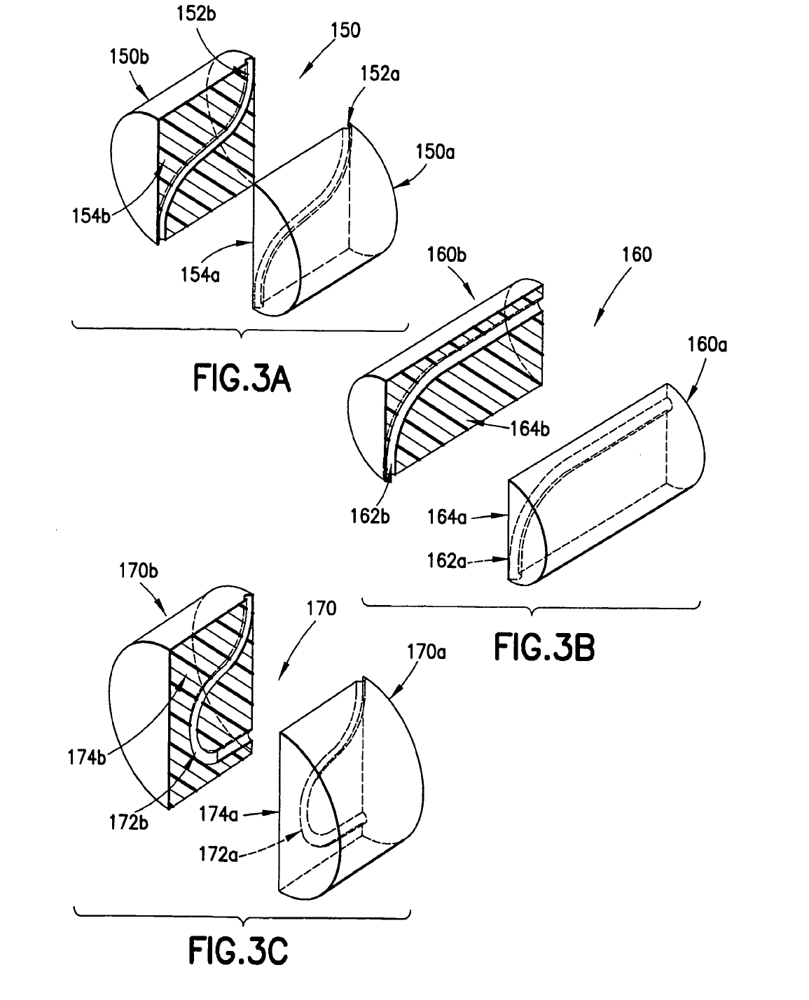

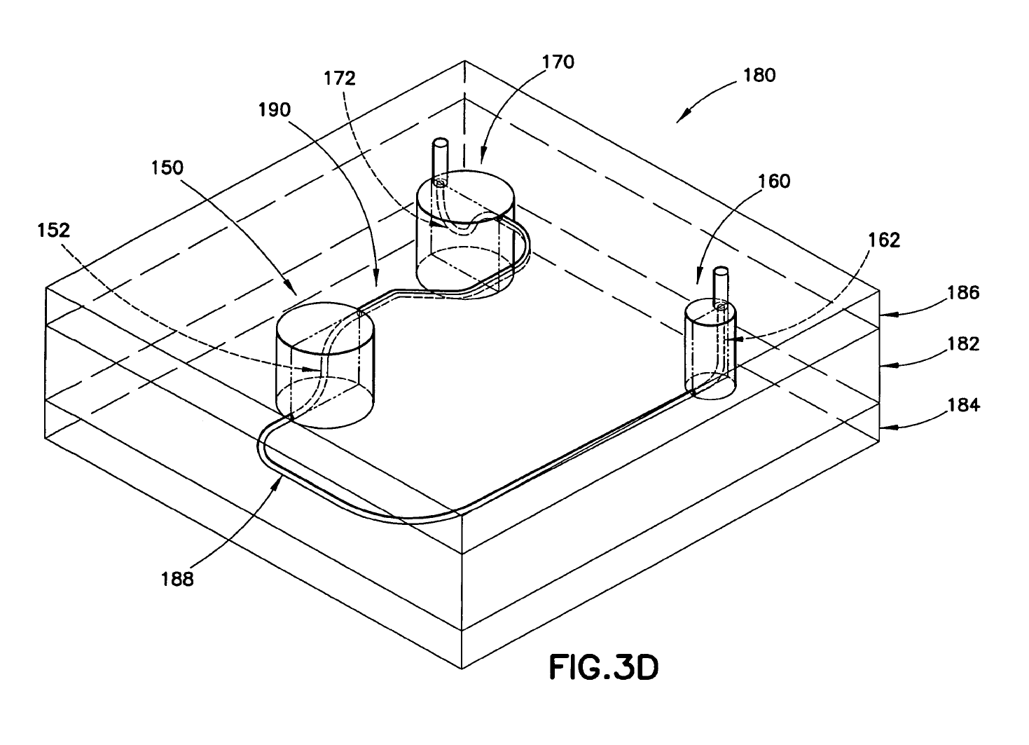

With reference to FIGS. 3A-3D in some embodiments, an insert or plug may be split axially lengthwise into two halves to create a desired transition fluid passageway that may be customized for a given application. The split insert or plug may have a desired shape for example, cylindrical, oblong or other shape. As shown in FIGS. 3A-3C, a groove or track generally designated 152, 162, 172 following a curved path to provide the desired transition fluid passageway route is machined or milled in a lengthwise face surface 154a, 154b, 164a, 164b, 174a, 174b in at least one split half 150a, 150b, 160a, 160b, 170a, 170b of the cylindrical insert 150, 160, 170 and closed off by a lengthwise face surface of the other split half of the cylindrical insert. Mirrored grooves 152a, 152b, 162a, 162b, 172a, 172b may be machined or milled in each respective split half face surface 154a, 154b, 164a, 164b, 174a, 174b to form a smooth transition fluid passageway when the split halves 150a, 150b, 160a, 160b, 170a, 170b of the respective plug 150, 160, 170 are placed in intimate contact with one another and received in a similar shaped opening or hole in a layer of the fluidic manifold in a similar manner as described herein above. In some embodiments the insert is made a permanent and immovable part of the layer by diffusion bonding or chemical bonding or by compressive forces on the insert or by other suitable means to carry out the intended function.

A fluidic manifold illustrating a possible fluidic pathway utilizing the split plugs 150, 160, 170 shown in FIGS. 3A-3C is shown in a schematic diagram in FIG. 3D and is generally designated 180 in which a middle layer 182 is sandwiched between a layer 184 and a layer 186. A fluid passageway generally designated 188 is formed between layers 182 and 184 connecting the respective openings or holes in the layer 182 which holes or openings are configured in complementary size and shape to receive respectively plugs 150 and 160. A fluid passageway generally designated 190 is formed between layers 182 and 186 connecting the respective openings or holes in the layer 182 which holes or openings are configured in a complementary size and shape to receive respectively plugs 150 and 170. As described herein above, the respective major face surfaces of the layers 182, 184, 186 are machined or milled with grooves or tracks to intersect and terminate in the inner peripheral wall of the respective holes or openings to coincide with the transition fluid passageways 152, 162, 172 in the split plugs 150, 160, 170. When the layers 184 and 186 are added to sandwich the layer 182 the respective layers 184 and 186 cover the grooves or tracks in the respective major face surfaces of layer 182 to create a sealed leak tight fluid passageway. The cylindrical insert 150 is shown with an “S”-shaped curved path 152 that is particularly useful in providing a transition fluid passageway between fluid pathways located on different major face surfaces between layers. The cylindrical insert 160 is shown with a “J”-shaped curved path 162 that is particularly useful in providing a transition fluid passageway between a fluid pathway located on a major face surface of a layer and a fluid pathway normal to the major face surface. The cylindrical insert 170 is shown with a “P”-shaped curved path 172 that is particularly useful in providing a transition fluid passageway between a fluid pathway near the surface of a layer and a fluid pathway normal to the major face surface. It will be appreciated that the respective transition fluid passageways follow a smooth curved path without sharp 90° right angle turns to minimize fluid back pressure turbulence and fluid friction in addition to being cleanable by a “fish line” or other wire product. It will also be appreciated the plugs 150, 160, 170 may be keyed or indexed to facilitate alignment and assembly of the fluidic manifold 180. In some embodiments the insert is made a permanent and immovable part of the layer by diffusion bonding or chemical bonding or by compressive forces on the insert or by other suitable means to carry out the intended function.

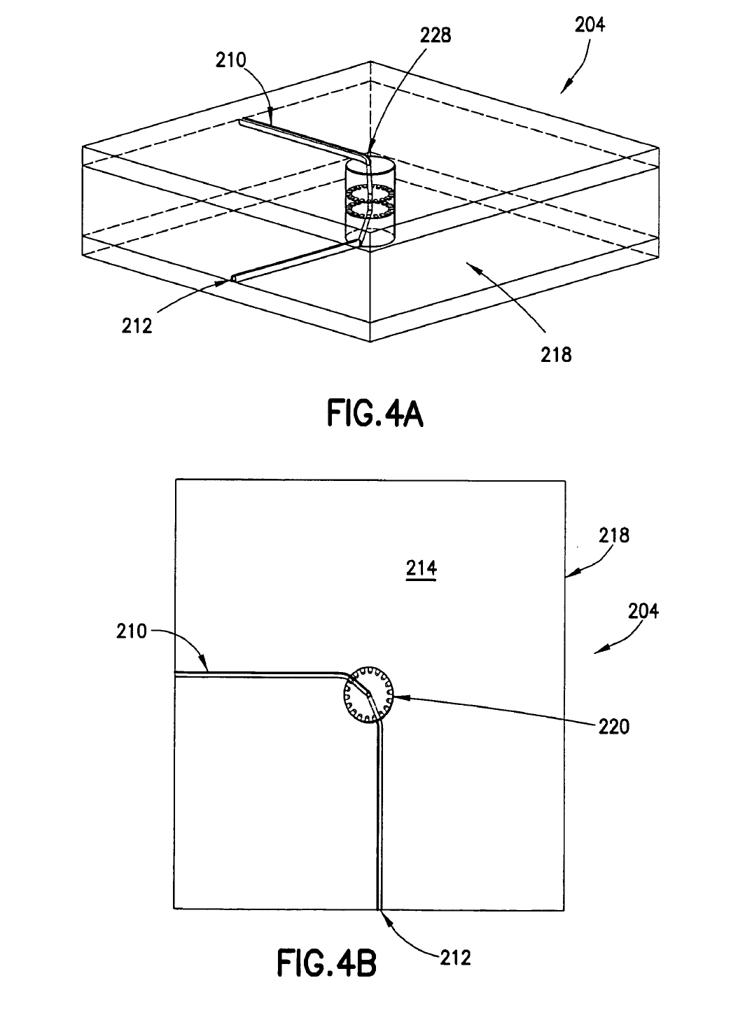

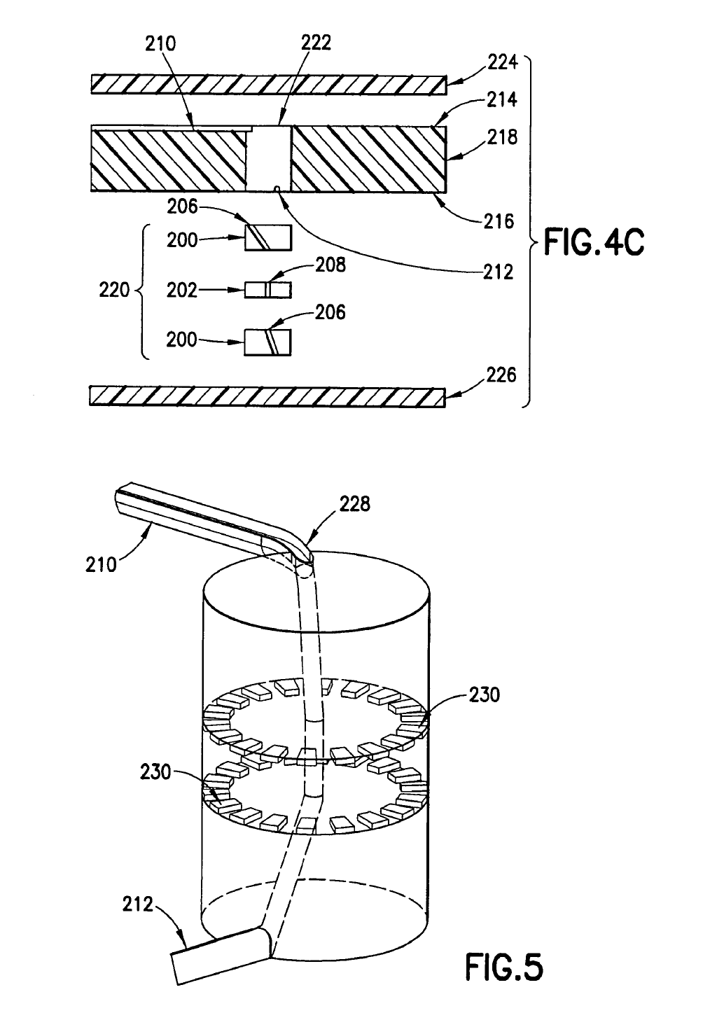

With reference to FIGS. 4A-4C in some embodiments of the present invention, the fluid transition passageway is formed from an insert or plug configured from a stack of angled hole inserts generally designated 200 and straight hole inserts generally designated 202 and shown in an exploded cross-section schematic view of a fluidic manifold generally designated 204 in FIGS. 4A and 4B. The hole 206 in the angled hole insert 200 and the hole 208 in the straight hole insert 202 are in a lengthwise orientation and the inserts 200, 202 are stackable and rotatable with respect to one another so that the respective holes 206, 208 in combination and in cooperation with holes in an adjacent straight hole insert 202 or angled hole insert 200 may be aligned to provide a desired transition fluid passageway 228 between fluid pathways 210, 212 located on oppositely disposed major face surfaces of a middle layer 218 of the fluidic manifold 204. The stacked inserts 200, 202 are configured to be rotated and aligned with respect to one another to create a curved path to provide the desired leak tight transition fluid passageway 228. In some embodiments the aligned stacked inserts are bonded to one another to pre-form for example a one piece plug 220 which is then received in a similar shaped and sized opening or hole 222 in the layer 218. The layer 218 is sandwiched between layers 224 and 226 as discussed herein above to close off the grooves forming the fluid pathways 210, 212. The angled holes 206 in the stack of angled hole inserts 200 and straight hole inserts 202 of the plug 220 forming the leak tight transition fluid passageway 228 reduces back pressure turbulence and fluid friction and are easily cleanable with a “fish line” or other wire-like product known to those in the art. In some embodiments the angled hole inserts and straight hole inserts are configured as shown in an enlarged view of the plug 220 to have castellations 230 on adjacent facing surfaces as illustrated in a perspective diagrammatic view in FIG. 5 to facilitate maintaining the relative angles of the holes 206, 208 and locations with respect to one another in the stack. In some embodiments the insert stack is made a permanent and immovable part of the layer by diffusion bonding or chemical bonding or by compressive forces on the insert or by other suitable means to carry out the intended function.

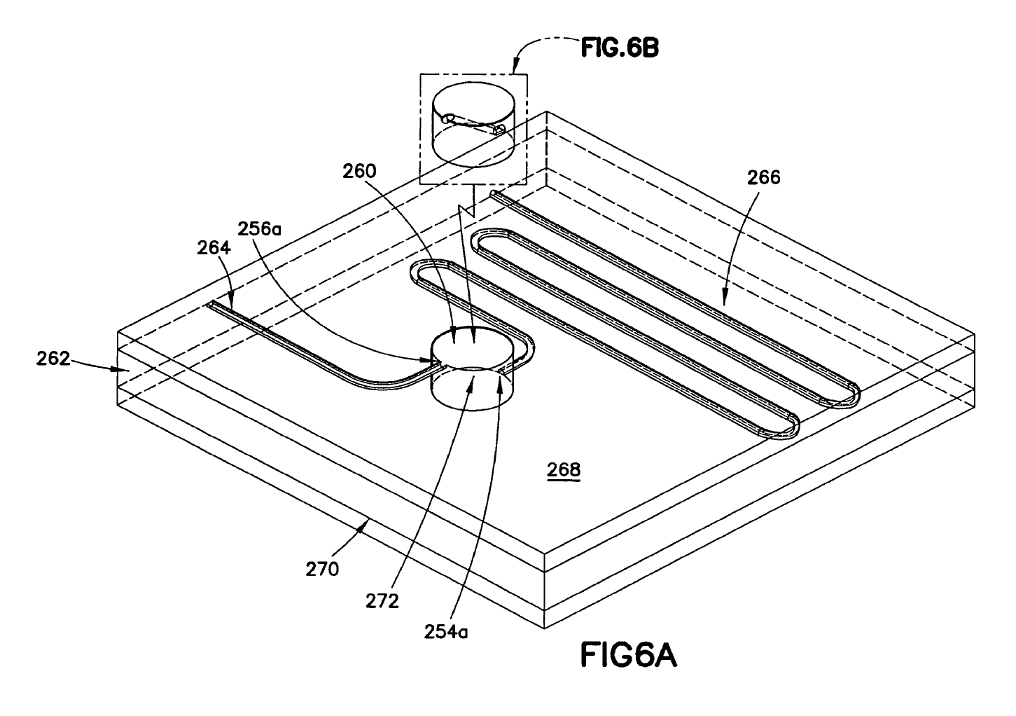

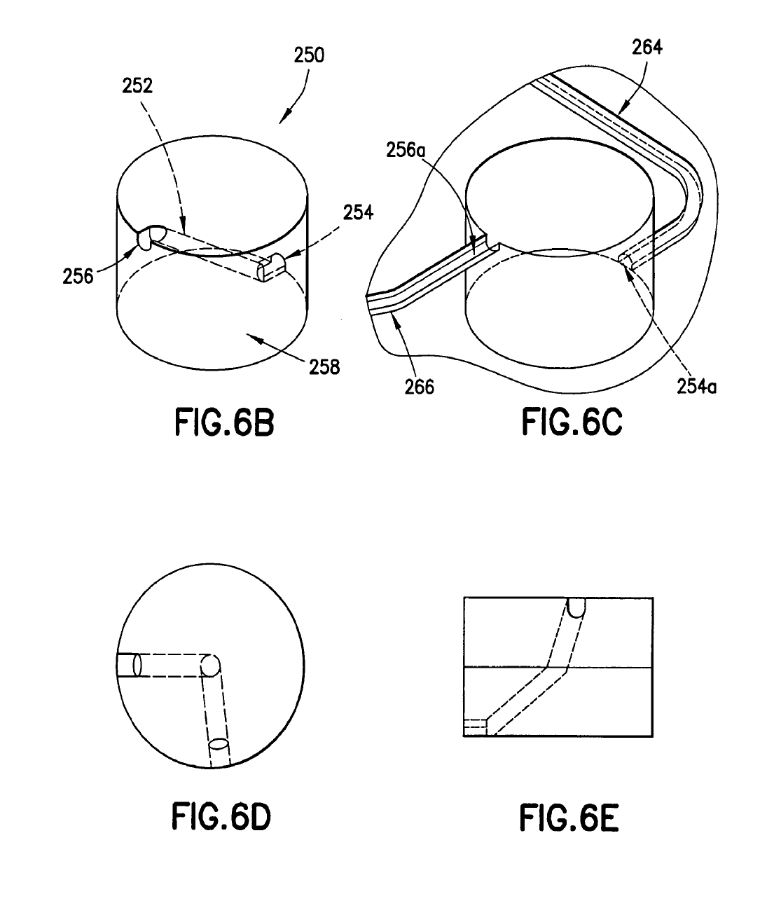

With reference to FIGS. 6A-6D in some embodiments of the present invention, an insert or plug generally designated 250 is machined or molded with a hole 252 in a radial orientation between desired end locations 254, 256 on the peripheral wall surface 258 of the plug 250 as illustrated schematically in FIG. 6B. The plug 250 is configured to have a size and shape to be received in a similarly sized and shaped opening or hole 260 in a layer 262 of a fluid manifold for example as shown in a schematic diagram in FIG. 6A wherein the layers sandwiching the layer 262 are shown but not identified in the Figure. As shown in FIGS. 6A and 6C the end portions 254a and 256a of the grooves or tracks forming the fluid passageways 264, 266 on the respective oppositely disposed major face surfaces 268, 270 of the layer 262 are machined or milled to coincide with the respective end locations 254, 256 of the angled hole in the plug 250 such that when the plug 250 is inserted in the opening or hole 260 in the layer 262 the angled hole in the plug 250 provides a leak tight fluid transition passageway 272 between the fluid pathways 264, 266. The hole through the plug 250 can be customized at any angle to an application specific to the fluidic manifold or alternately the hole through the plug may be at a predetermined angle and a fluidic manifold can be designed incorporating the standardized angled hole plug. In some embodiments the angled hole in the plug can be made of two different angled holes intersecting interior of the plug for example as shown in the schematic cross-sections of a plug illustrated in FIGS. 6D and 6E. Any combination of angled holes in the plug may be used to meet specific design requirements of a fluidic manifold. The angled hole plug provides a non-right angle smooth leak tight transition fluid passageway turn that minimizes back pressure turbulence and fluid friction in addition to being cleanable by a “fish line” or other wire product. In some embodiments the insert is made a permanent and immovable part of the layer by diffusion bonding or chemical bonding or by compressive forces on the insert or by other suitable means to carry out the intended function.

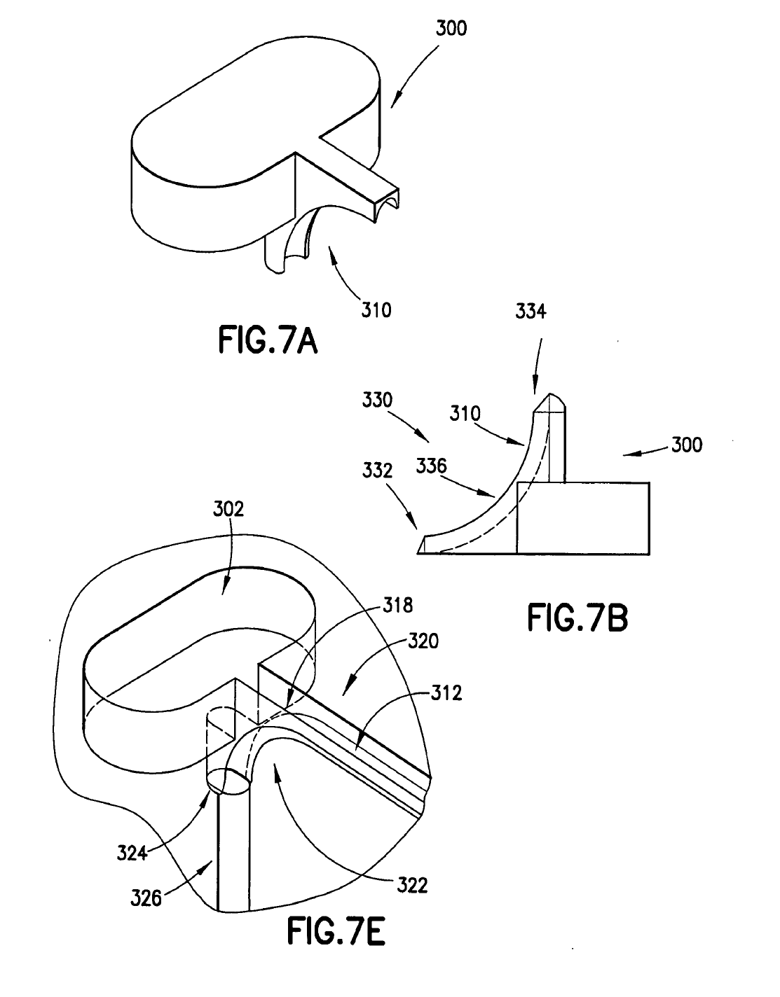

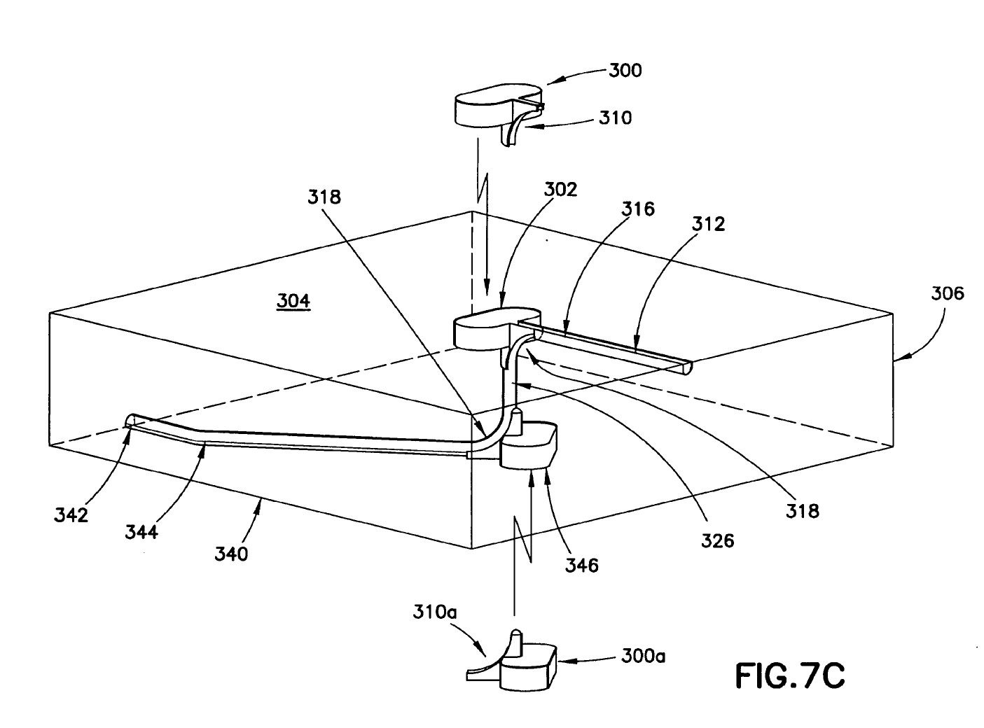

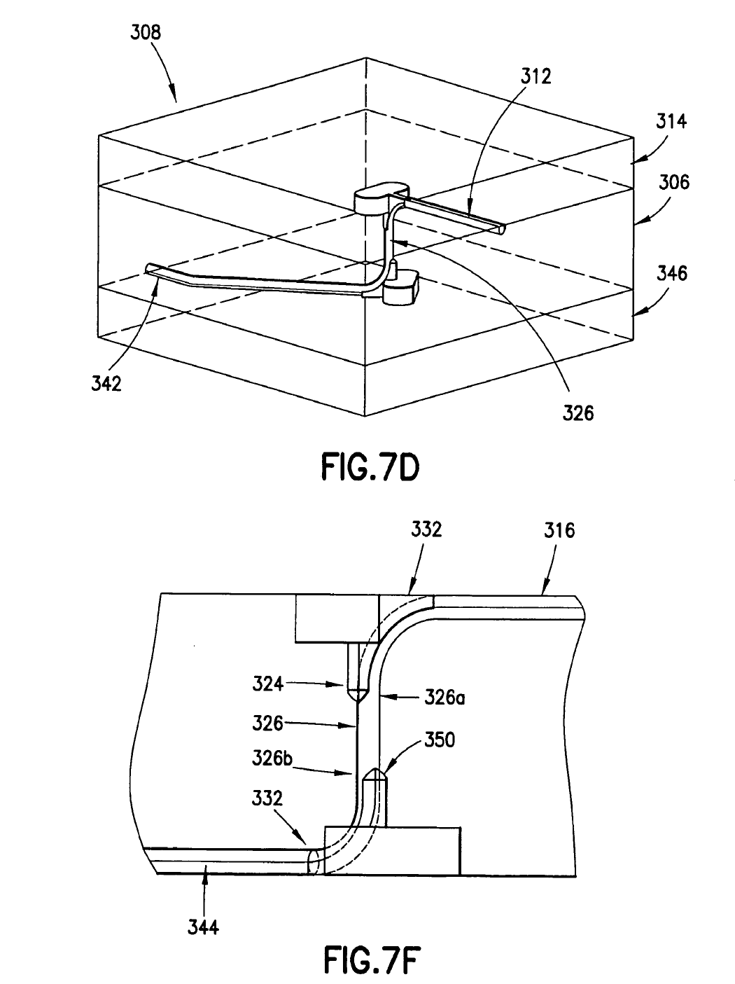

With reference to FIGS. 7A-7F in some embodiments of the transition fluid passageway of the present invention a surface of a “ski jump” plug or insert generally designated 300 is configured to operate in a cooperating facing relationship with a complementary matching surface in an opening for example a cavity or pocket 302 in the surface 304 of a layer 306 of a fluidic manifold 308 to form a smooth non-right angle transition fluid pathway turn in a fluid pathway. In some embodiments the “ski jump” plug or insert 300 has an inner facing concave curved surface 310 that projects into the pocket 302 in the layer 306. The pocket 302 is machined or milled in the surface of the layer 306 and is configured to be similarly sized and shaped to the “ski jump” plug 300. In this example, a groove or track 312 is machined or milled in the major face surface 304 of the layer 306 and forms a fluid pathway 316 when the groove 312 is closed off by a sandwiching layer 314. The groove 312 is continued along major face surface 304 to one end 320 of a shoulder 322 in the pocket 302 and along an outer facing convex surface 318 to an opposite distal end 324 of the shoulder 322 and intersecting at the opposite end 324 with a fluid passageway 326 in the layer 306 substantially normal to the plane of the major face surface 304. The “ski jump” plug 300 has an inner facing concave curved segment 330 that extends at one end 332 to the portion of the fluid pathway 316 in the major face surface 304 of the layer 306 and at the opposite end 334 to the hole 326 in the layer 306 forming the fluid passageway. A groove 336 is machined or milled in the inner facing concave curved surface 310 that mirrors the groove in the outer facing convex surface 318 of the pocket 302. A smooth non-sharp leak tight transition fluid passageway is formed and defined between the inner facing concave curved surface 310 of the “ski jump” plug 300 and the outer facing convex surface 318 of the pocket 302 in the layer 306 when the “ski jump” plug 300 is received in the pocket 302. In some embodiments the “ski jump” insert is made a permanent and immovable part of the layer by diffusion bonding or chemical bonding or by compressive forces on the insert or by other suitable means to carry out the intended function.

In some embodiments, two “ski jump” plugs 300 may be arranged as illustrated in the schematic diagram of a fluidic manifold 308 shown in FIGS. 7C and 7D and in an enlarged view in FIG. 7F to provide a smooth transition fluid passageway between fluid pathways located on oppositely disposed major face surfaces 304 and 340 of a layer 306 of the fluidic manifold 308. In this example, a first fluid pathway 316 is formed on the major face surface 304 of the layer 306 of the fluid manifold 308 as described above. A groove or track 342 is machined or milled on an oppositely disposed major face surface 340 of the layer 306 and forms a second fluid pathway 344 when the groove 342 is closed off by a sandwiching layer 346. In a similar manner as discussed in connection with FIG. 7B and 7E, a first pocket 302 is machined or milled in the major face surface 304 of the layer 306 and is configured to have a substantially similar size and shape to receive a respective “ski jump” plug 300. A second pocket 346 is machined or milled on an oppositely disposed major face surface 340 of the layer 306 to receive a respective “ski jump” plug 300a. A hole 326 in the layer 306 forms an internal fluid passageway normal to the major face surfaces 304 and 340 and an end 326a intersects with a distal end 324 of the pocket 302 and an end 326b intersects with a distal end 350 of the pocket 346. Each of the “ski jump” plugs 300, 300a has an inner facing concave curved surface 310 and 310a that extends at one end 332 to the end region of the respective fluid pathway 316, 344 in the respective major face surface 304, 340 of the layer 306 and at the opposite end 334 to the respective end 326a, 326b of the hole 326 forming the internal fluid passageway in the layer 306. As discussed above a groove 336 is machined or milled in the inner facing concave curved surface 310 of the respective “ski jump” plug 300, 300a that mirrors the groove 318 in the outer facing convex surface of the respective corresponding pocket 302, 346. A smooth non-sharp leak tight turn in the fluid pathway is formed at each respective corresponding “ski jump” plug 300, 300a and pocket 302, 346 between the inner facing concave curved surface 310 of the “ski jump” plug and the outer facing convex grooved surface 318 of the pocket 302, 346 in the layer 306 when a respective “ski jump” plug 300, 300a is received in its respective pocket 302, 346 thereby creating a leak tight or fluid tight transition fluid passageway between the fluid pathways 316, 344 located on the respective major face surfaces 304, 340 of the layer 306. In some embodiments the “ski jump” insert is made a permanent and immovable part of the layer by diffusion bonding or chemical bonding or by compressive forces on the insert or by other suitable means to carry out the intended function.

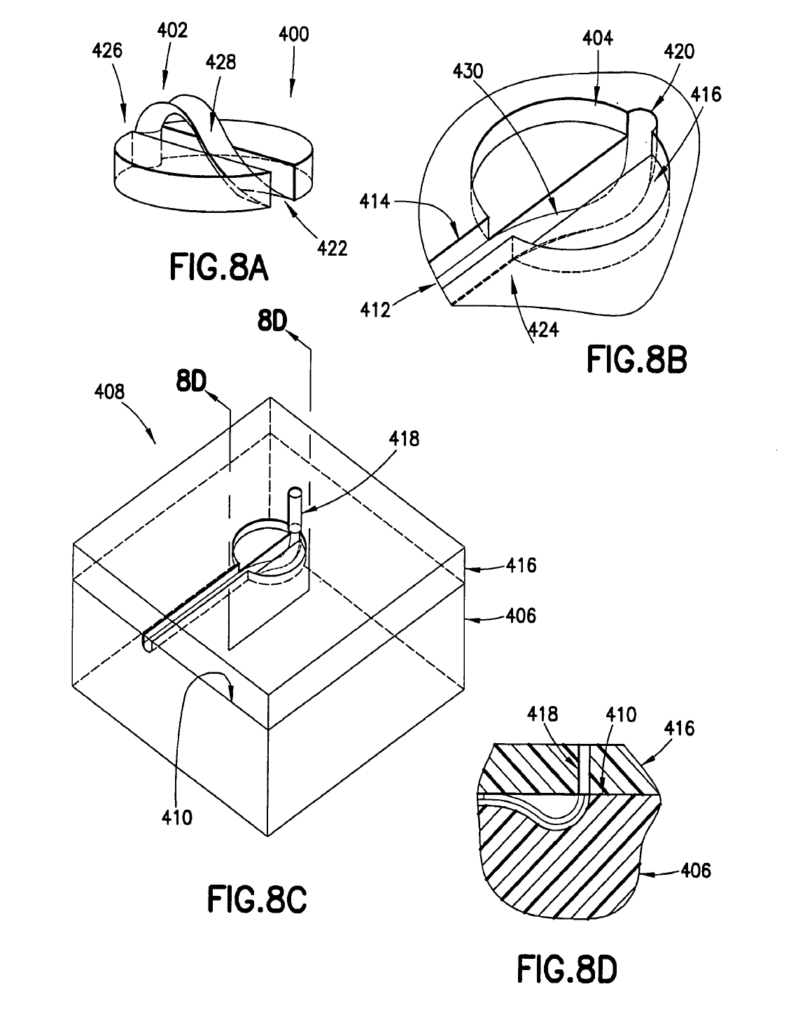

With reference to FIGS. 8A-8D in some embodiments, a “ski jump” plug generally designated 400 has an inner facing convex curved surface 402 that projects into an opening for example a cavity or pocket 404 in a layer 406 of a fluidic manifold 408. The pocket 404 is machined or milled in the surface 410 of the layer 406 and is configured to have substantially the same size and shape to receive the “ski jump” plug 400. A groove or track 412 is machined or milled in the major face surface 410 of the layer 406 and forms a fluid pathway 414 when the groove 412 is closed off by a sandwiching layer 416. The groove 412 forming the fluid pathway 414 is continued along the outer facing concave surface 416 of the pocket 404 and intersects with a hole 418 in the sandwiching layer 416 and substantially normal to the plane of the major face surface 410 at the distal end 420 of the pocket 404. The “ski jump” plug has an inner facing convex curved surface 402 that extends at one end 422 to the end portion 424 of the fluid pathway 414 in the major face surface 410 of the layer 406 and at the opposite end 426 to the hole 418 redirecting the fluid pathway in the layer 406. A groove 428 is machined or milled in the inner facing convex curved surface 402 that mirrors a groove 430 in the outer facing concave surface 416 of the pocket 404. A smooth turn leak tight transition fluid passageway in the fluid pathway 414 is formed between the inner facing convex curved surface 402 of the “ski jump” plug 400 and the outer facing concave grooved surface 416 of the pocket 404 in the layer 406 when the “ski jump” plug is received in the pocket 404. In some embodiments the “ski jump” insert is made a permanent and immovable part of the layer by diffusion bonding or chemical bonding or by compressive forces on the insert or by other suitable means to carry out the intended function.

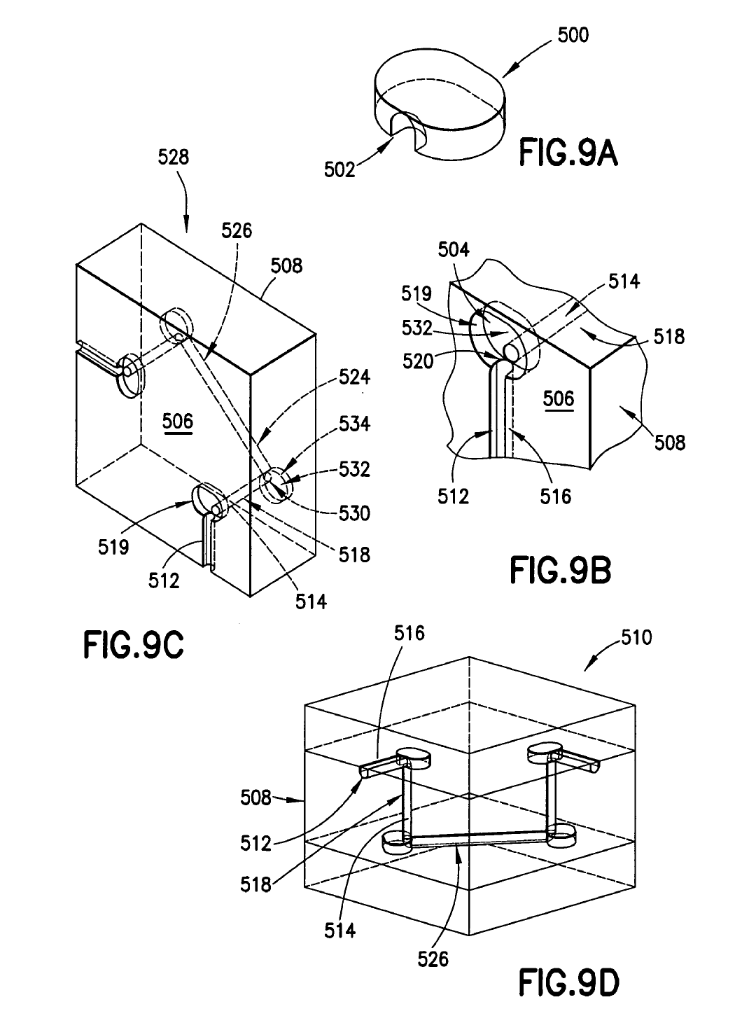

With reference to FIGS. 9A-9D in some embodiments of the invention the inner facing surface 502 of a plug or insert 500 is machined or milled with a radius and configured as an elbow. The elbow plug 500 may be of any desired shape and is configured to be received in a complementary sized and shaped opening for example a cavity or pocket 504 machined or milled in a major face surface 506 of a layer 508 in a fluidic manifold 510. The size of the groove or track of the curvature of the inner facing elbow surface 502 is configured to match the size of the groove or track 512 and the hole 514 that form the respective two fluid passageways 516 and 518 that are positioned substantially normal to one another at a desired location 520 along the peripheral wall 519 of the pocket 504 in the layer 508. The peripheral wall 519 is further machined or milled with a radius matching the curvature of the inner facing surface 502 of the elbow plug 500. A smooth turn transition fluid passageway between the fluid pathways 516 and 518 in the respective major face surface 506 of the layer 508 and a hole 514 in the layer 508 forming a fluid pathway 518 normal to the major face surface 506 is created when the elbow plug 500 is received in the pocket 504. The elbow plug transition fluid passageway minimizes back pressure turbulence and fluid friction and is snakeable with a fishline or other wire product to clear or remove potential blockages. In some embodiments the elbow plug insert is made a permanent and immovable part of the layer by diffusion bonding or chemical bonding or by compressive forces on the insert or by other suitable means to carry out the intended function.

In some embodiments of the invention two elbow plugs 500, 500 may be used to create a smooth clog resistant transition fluid passageway between fluid pathways 512 and 526 located on oppositely disposed major face surfaces 506 and 528 respectively of a layer 508 in a fluidic manifold 510 as illustrated in the schematic diagram in FIGS. 9C and 9D. In this example, a groove or track 512 is machined or milled in the surface 506 of the layer 508 and terminates in the peripheral wall 519 at one side of a pocket 504 which is machined or milled in the surface 506 of the layer 508. A hole 514 is drilled through the layer 506 and is positioned with respect to the groove or track 512 terminating in the peripheral wall 519 of the pocket 504 to form a fluid pathway 518 normal to the major face surface 506 of the layer 508. A smooth turn transition fluid passageway is created between the fluid pathway 516 in the surface 506 of the layer 508 and the hole 514 when the elbow plug 500 is received in the pocket 504. The end 530 of the hole 514 at the oppositely disposed major face surface 528 terminates in the base wall surface 532 of a pocket 534 machined or milled in the surface 528 of the layer 508. A groove or track 524 is machined or milled in the surface 528 of the layer 508 and terminates in the peripheral wall 519 at one side of the pocket 534 and is positioned with respect to the end 530 of the hole 514. A smooth turn transition fluid passageway is created between the end 530 of the hole 514 and the fluid pathway 526 in the surface 528 of the layer 508 when the elbow plug 500 is received in the pocket 534. It will be seen that a number of elbow plugs 500, 500 may be utilized in this manner to create transition fluid passageway between fluid pathways on oppositely disposed surfaces of the layer to create a cross-over to accommodate a crossing fluid pathway in the layer. In some embodiments the elbow plug insert is made a permanent and immovable part of the layer by diffusion bonding or chemical bonding or by compressive forces on the insert or by other suitable means to carry out the intended function.

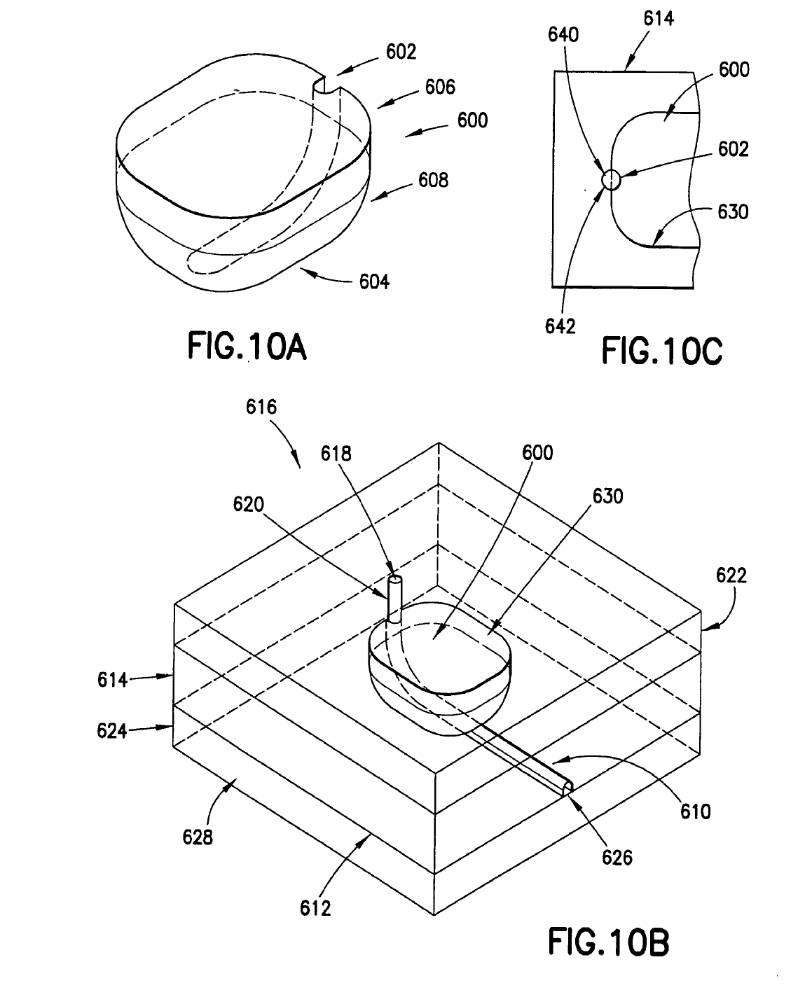

With reference to FIGS. 10A-10B in some embodiments a plug or insert 600 is configured in a pillow-like shape and is machined or milled with a groove or track 602 along a bottom portion 604 and side portion 606 of its perimeter on an inner facing surface 608 to provide a transition fluid passageway between a fluid passageway 610 on a major face surface 612 of a layer 614 in a fluidic manifold 616 and a hole 618 forming a second fluid passageway 620 through a sandwiching layer 622. A layer 624 closes off a groove or track 626 forming the fluid pathway 610 on the major face surface 628 of the layer 614. An opening for example a cavity or pocket 630 having a shape and size substantially the same as the pillow-like plug 600 is machined or milled in the layer 614 and is positioned so that the groove or track 602 along the bottom portion 604 of the perimeter of the inner facing surface 608 of the plug 600 is aligned with the groove or track 626 forming the fluid passageway 610 on the major face surface 628 of the layer 614 such that a smooth turn transition fluid passageway is created between the hole 618 and the fluid pathway 610 in the surface 628 of the layer 614 when the pillow-like plug 600 is received in the pocket 630. In some embodiments as illustrated in a schematic top plan partial view in FIG. 10C, a groove or track 640 mirroring the groove or track 602 along the outer facing surface of the pillow-like plug 600 is machined or milled in the outer facing surface of the pocket 630 in layer 614 such that a tubular or round channel fluid pathway 642 is formed when the pillow-like plug 600 is received in the pocket 630. In some embodiments the pillow-like insert is made a permanent and immovable part of the layer by diffusion bonding or chemical bonding or by compressive forces on the insert or by other suitable means to carry out the intended function.

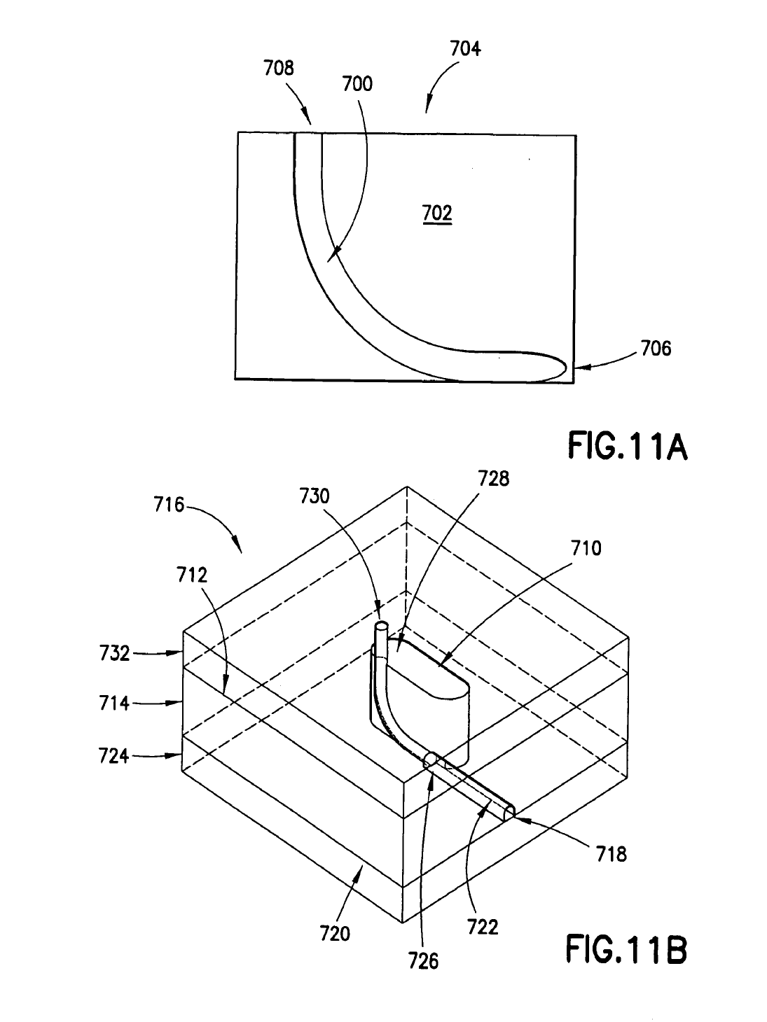

With reference to FIGS. 11A-11B in some embodiments a groove or track 700 is machined or milled in the side face surface 702 of an insert or plug generally designated 704 to follow a smooth non-right angle curved path so that the groove 700 transitions from an inner facing portion 706 of the plug 704 to an outer facing portion 708 of the plug 704. An opening for example a cavity or pocket generally designated 710 having a substantially same size and shape as the insert or plug 704 is machined or milled in the surface 712 of a layer 714 in a fluidic manifold 716. A hole 730 is drilled through the sandwiching layer 732 and is positioned with respect to the outer facing portion of the plug 704 when the plug 704 is received in the pocket 710 in the layer 714. A groove or track 718 is machined or milled in the major face surface 720 of the layer 714 and forms a fluid passageway 722 when closed off by a mating surface a sandwiching layer 724 in intimate contact with the major face surface 720. The pocket 710 is positioned with respect to the groove or track 718 forming the fluid passageway 722 to enter the pocket 710 at the side 726 corresponding to the grooved face side surface 702 of the plug 704 and is closed off by the inner facing peripheral wall surface 728 of the pocket 710 so that a smooth turn transition fluid passageway is created between the hole 730 and the fluid pathway 722 in the surface 720 of the layer 714 when the plug 704 is received in the pocket 710 in the layer 714. The side face surface 702 of the insert or plug 704 may be machined or milled with a groove or track following a desired curved path for example, an “S”-shaped curved path, a “J”-shaped curved path and an “P”-shaped curved path to create a leak tight transition fluid pathway to provide features similar to those discussed above in connection with FIGS. 3A-3C. In some embodiments the insert is made a permanent and immovable part of the layer by diffusion bonding or chemical bonding or by compressive forces on the insert or by other suitable means to carry out the intended function.

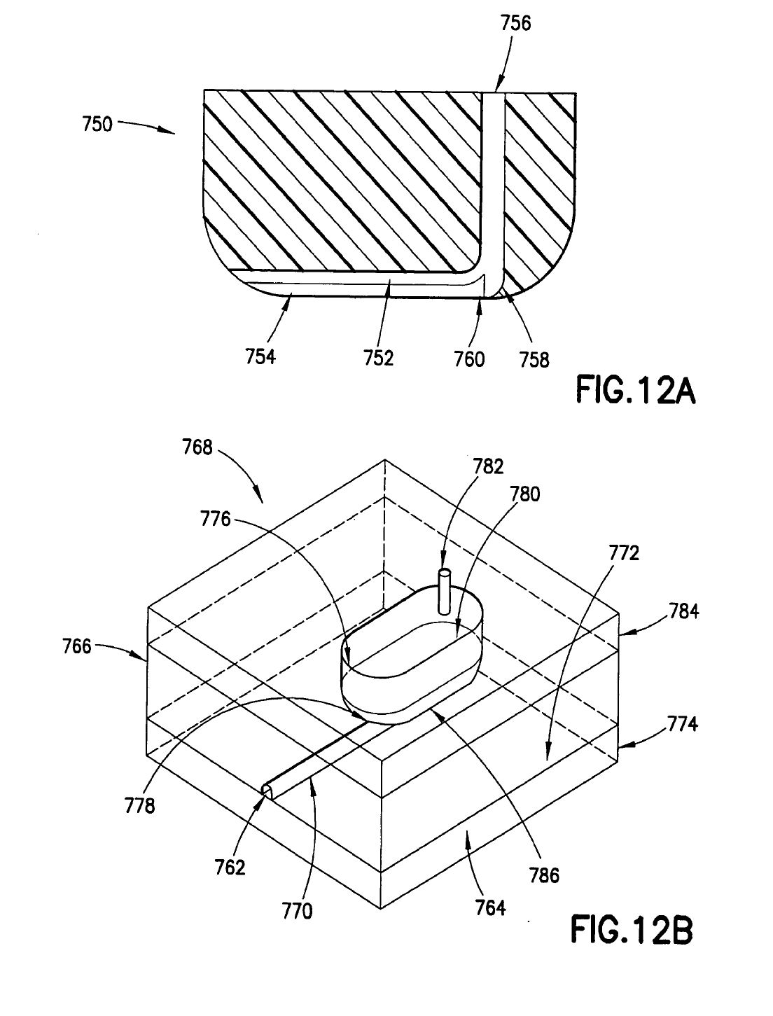

With reference to FIGS. 12A-12B in some embodiments a plug or insert 750 is molded in a pillow-like shape with a groove or track 752 machined or molded following the perimeter along a centerline in the bottom outward facing surface 754 of plug 750. A hole 756 is drilled or molded in the plug 750 and substantially perpendicular to the track 752 and having one end 758 molded with a radius and intersecting the end 760 of the track 752 in the bottom outward facing surface 754. A groove or track 762 is machined or milled in the major face surface 764 of a layer 766 of the fluidic manifold 768 and creates a fluid passageway 770 when closed off by a mating surface 772 of a sandwiching layer 774 in intimate contact with the major face surface 764. The groove or track 762 on the surface 764 of the layer 766 extends into and terminates in a peripheral wall 776 in the bottom portion 778 of an opening for example a cavity or pocket 780 machine or milled in the layer 766. A hole 782 is drilled through the sandwiching layer 784 and is positioned to be in alignment with the hole 756 in the plug 750 when the plug 750 is received in the pocket 780 in the layer 766. The groove or track 752 in the bottom outward facing surface 754 of the plug 750 is closed off by an outer facing surface 786 in the base of the pocket 780 in the fluidic manifold 768 when the plug 750 is received in the pocket 780 in the layer 766. The hole 756 is substantially perpendicular to and over one end 760 of the groove or track 752 in the bottom outward facing surface 754 of the pillow-like shaped plug 750 and has a radius at the intersection with the track 752 so that a smooth turn transition fluid passageway is created between the hole 782 and the fluid pathway 770 in the surface 764 of the layer 766 when the pillow-shaped plug 750 is received in the pocket 780.

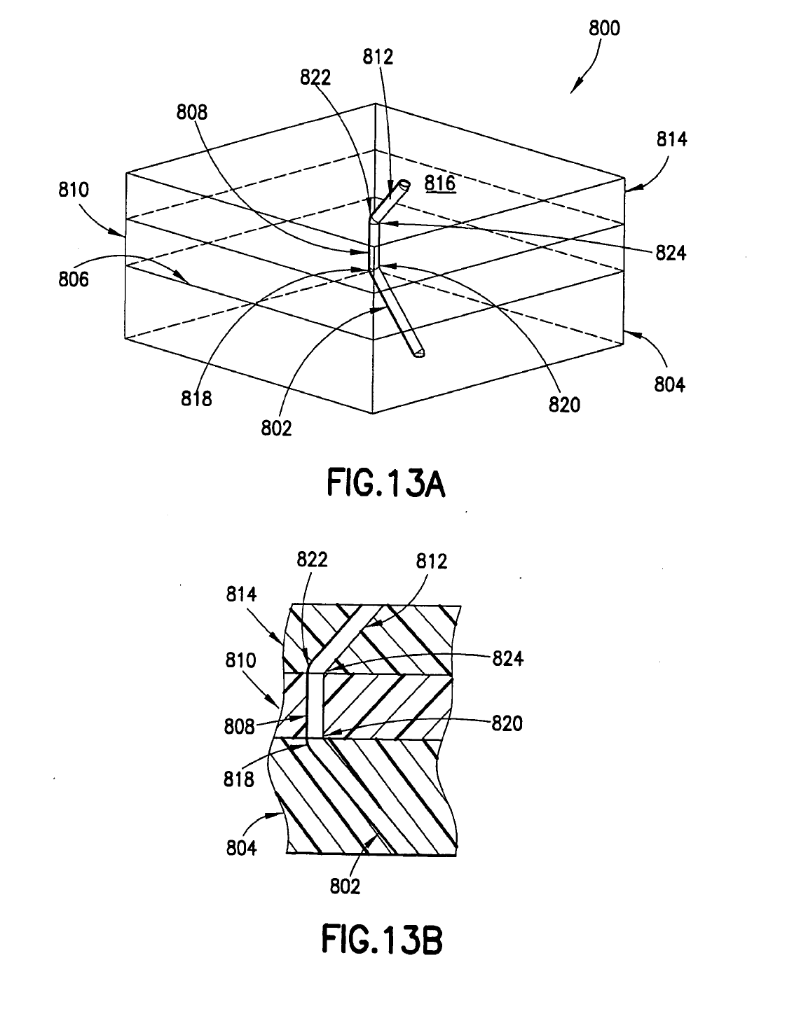

With reference to FIGS. 13A-13B in some embodiments a smooth non-right angle sharp turn transition fluid passageway is created between fluidic pathways in a fluidic manifold 800 is shown as a three layer fluidic manifold by drilling a hole 802 through one layer 804 at an angle relative to a major face surface 806 of the layer 804 to intersect a hole 808 drilled through an adjacent sandwiched layer 810 substantially normal to the major face surface 806. Another hole 812 is drilled through a layer 814 oppositely disposed the layer 810 at an angle relative to a major face surface 816 of the layer 814 to intersect the hole 808 drilled through the sandwiched layer 810 substantially normal to the major face surface 816. The end 818 of the hole 802 is configured at an angle at the intersection with the one end 820 of the hole 808. The end 822 of the hole 812 is configured at an angle at the intersection with the one end 824 of the hole 812. The holes 802 and 812 are drilled at a desired angle through the respect outer layers 804 and 814 to create a desired fluid pathway transition between the layers without sharp turn corners to minimize back pressure turbulence and fluid friction and is snakeable with a fishline or other wire product to clear or remove potential blockages.

In some embodiments of the present invention the transition region of the fluid pathway is machined to provide a leak tight clog resistant transition fluid pathway that is snakeable with a fishline or other wire product to clear or remove potential blockages caused by particulate accumulation to the extent that any accumulation occurs.

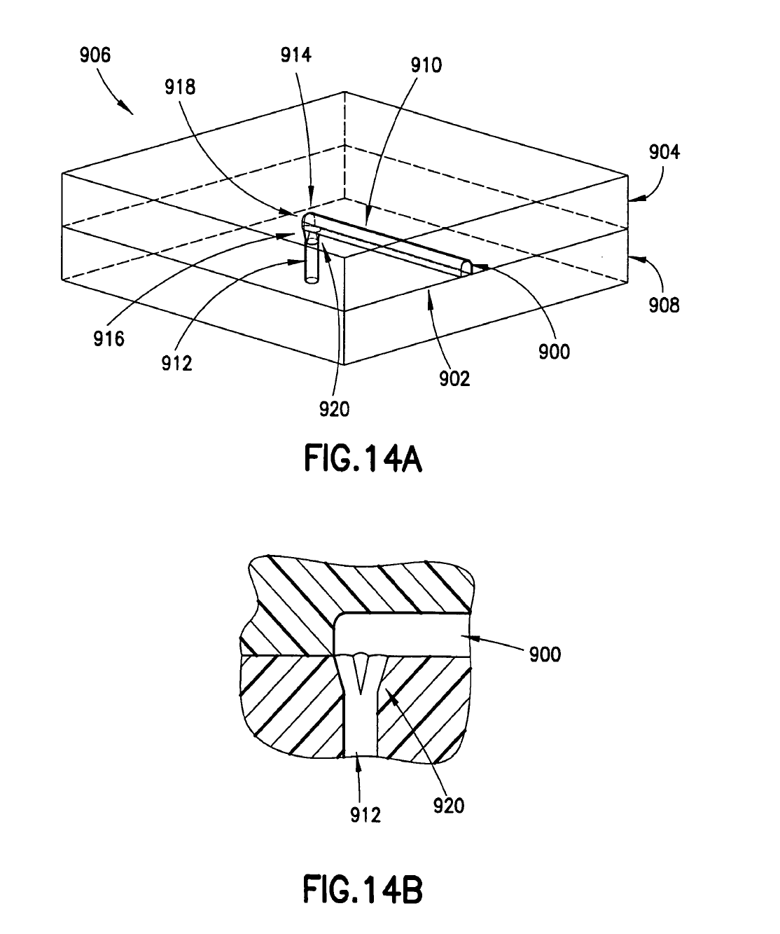

With reference to FIG. 14A-14B in some embodiments a groove or track 900 on one major face surface 902 of a layer 904 in a fluidic manifold 906 is closed off by a sandwiching layer 908 to create a fluid passageway 910 between the layers 904 and 908. A hole 912 is drilled through the layer 908 substantially perpendicular to and over one end 914 of the track 900 and forms a second fluid passageway 916. The end portion 918 of the hole 912 over the track 900 is machined to form a funnel like termination 920 that has a wider opening intersecting with the track 900 so that particulate can more easily flow through the transition without a sharp right angle turn and is clog resistant. The intersection of the funnel like termination 920 and the track 900 is snakeable with a fishline or other wire product.

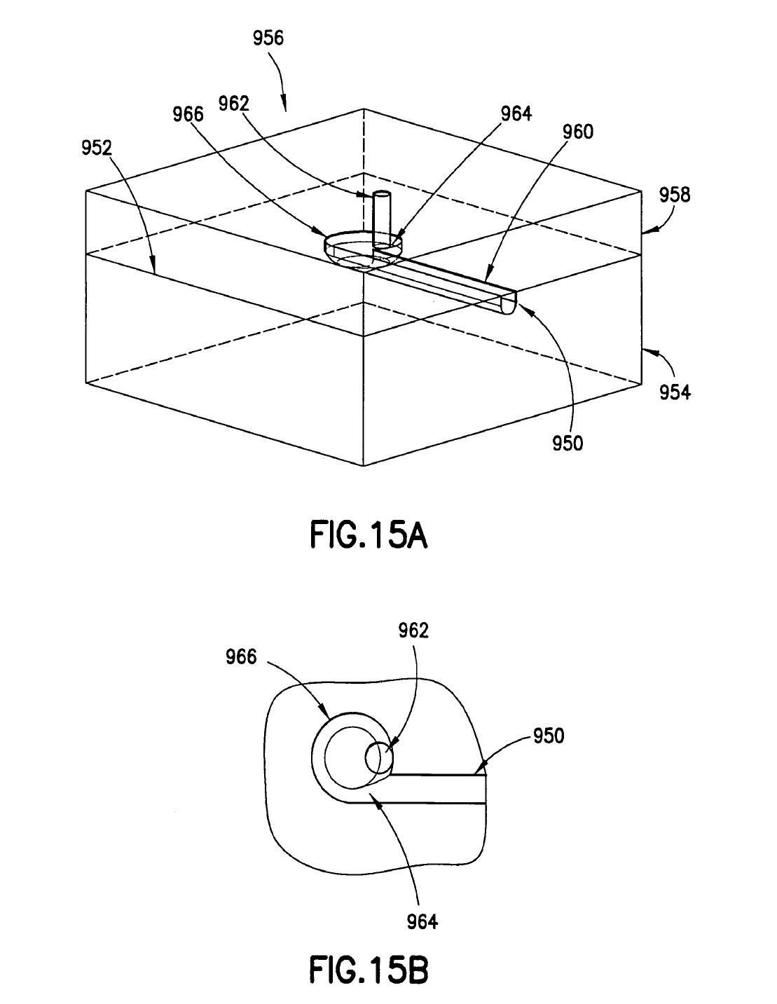

With reference to FIGS. 15A-15B in some embodiments a groove or track 950 on one major face surface 952 of a layer 954 in a fluidic manifold 956 is closed off by a sandwiching layer 958 to create a fluid passageway 960 between the layers 954 and 958. A hole 962 is drilled through the layer 958 substantially perpendicular to the track 950 and one end 964 of the hole 962 intersects with a localized enlargement 966 along a perimeter portion of the localized enlargement 966 near one end 968 of the track 950. The portion of the track 950 forming the end 968 is machined to follow a smooth curved path tangentially into the localized enlargement 966 to create a non-right angle smooth swirling fluid flow transition in the fluid path such that the transition fluid passageway has room to pass any particulate that may be carried by the swirling action of fluid passing in the fluid pathway.

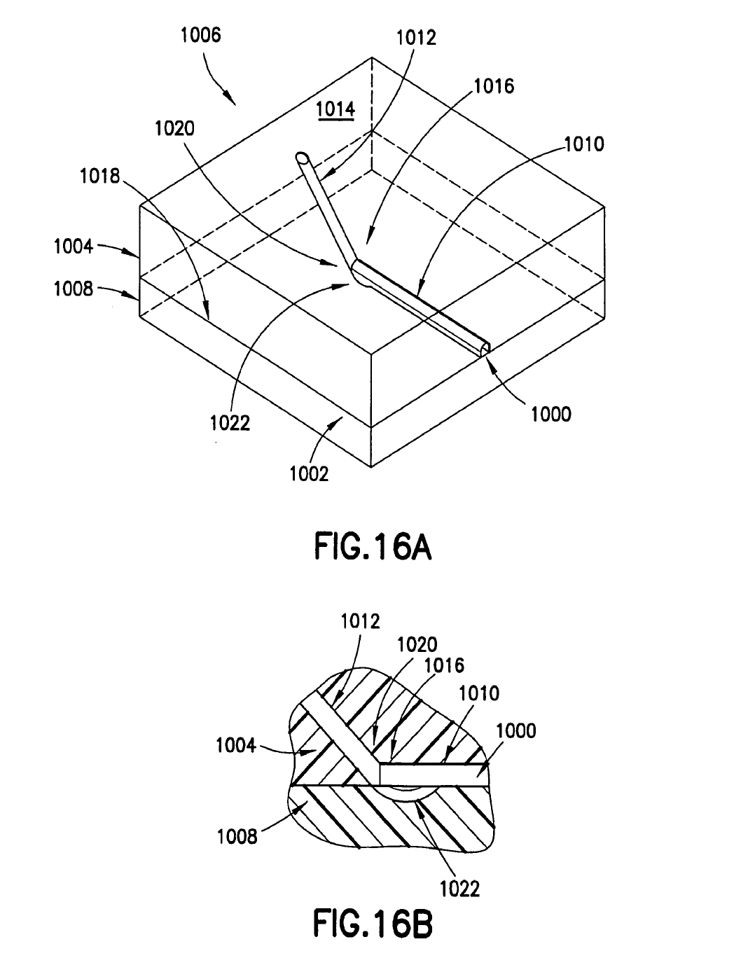

With reference to FIG. 16A-16B in some embodiments a groove or track 1000 on one major face surface 1002 of a layer 1004 in a fluidic manifold 1006 is closed off by a sandwiching layer 1008 to create a fluid passageway 1010 between the layers. A hole 1012 is drilled through the layer 1004 at a desired angle from the major face surface 1014 in a direction to intersect with one end 1016 of the track 1000. The major face surface 1018 of the sandwiching layer 1008 in the region of the intersection of the end 1016 of the track 1000 and the end 1020 of the hole 1012 is machined to create a dimple 1022 to provide an enlarged intersection and smooth flow fluid transition in the fluid path such that the transition fluid passageway has room to pass any particulate that may be carried by fluid passing in the fluid pathway.

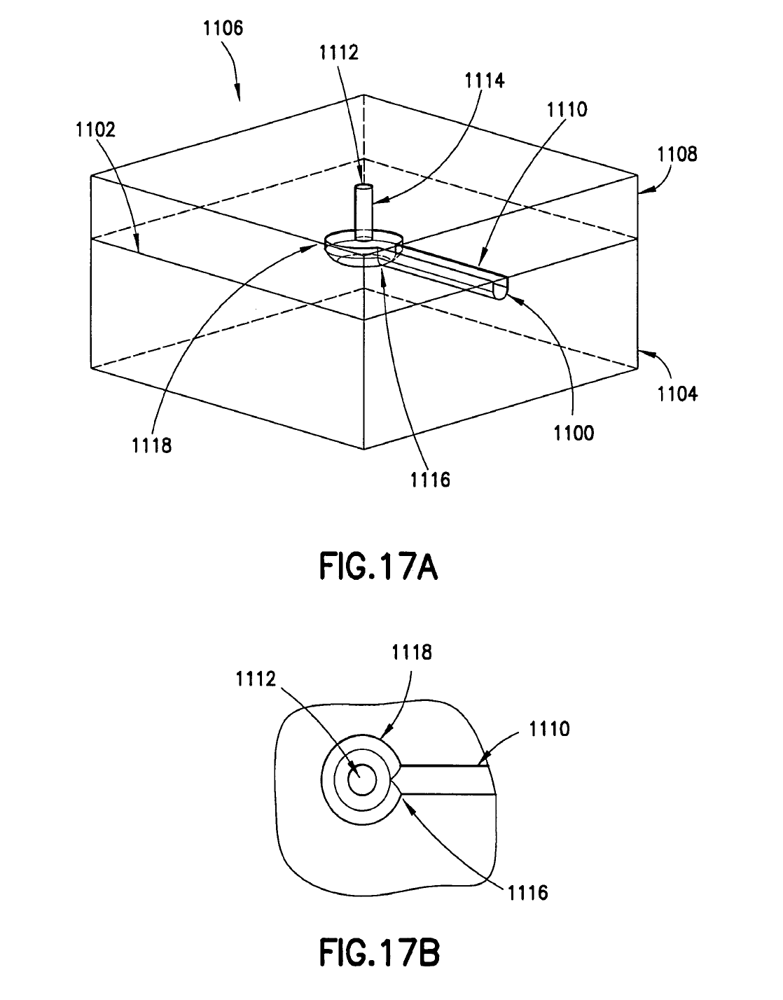

With reference to FIGS. 17A-17B in some embodiments a groove or track 1100 on one major face surface 1102 of a layer 1104 in a fluidic manifold 1106 is closed off by a sandwiching layer 1108 to create a fluid passageway 1110 between the layers. A hole 1112 is drilled through the layer 1108 substantially perpendicular to the major face surface 1102 to create a second fluid passageway 1114. The surface 1102 of the layer 1104 at the end portion 1116 of the track 1100 is further machined to a predetermined depth for example in the shape of a circle to provide a localized enlargement 1118 to create a smooth flow fluid transition in the fluid path such that the transition fluid passageway has room to pass any particulate that may be carried by fluid passing in the fluid pathway.

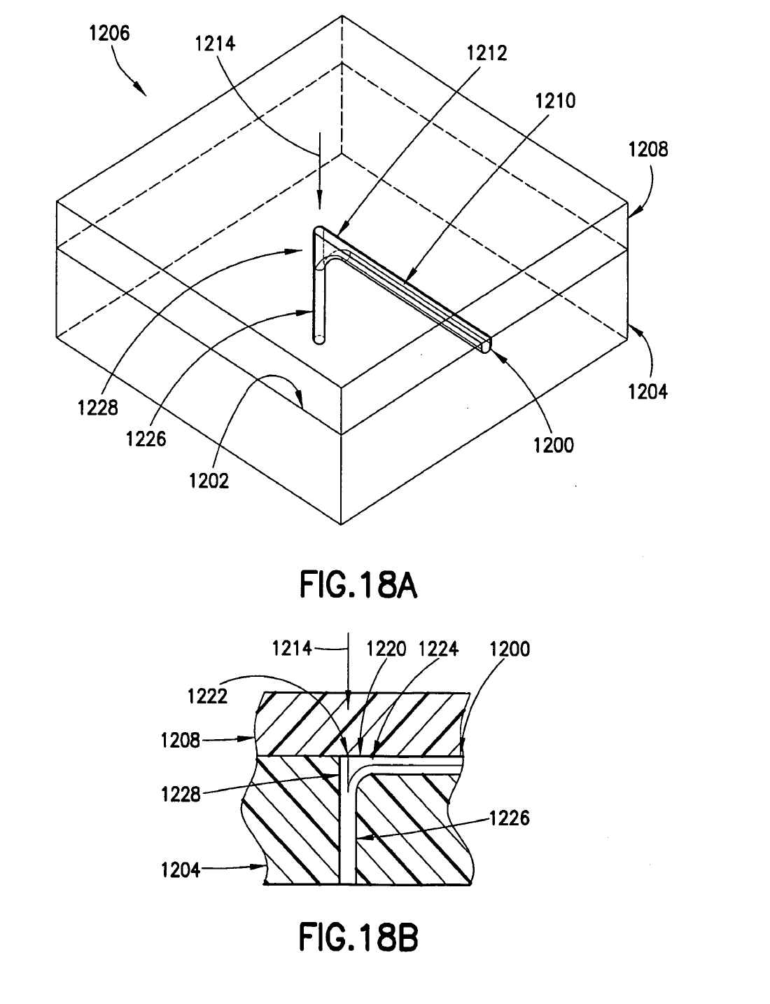

With reference to FIGS. 18A-18B in some embodiments a groove or track 1200 on one major face surface 1202 of a layer 1204 in a fluidic manifold 1206 is closed off by a sandwiching layer 1208 to create a fluid passageway 1210 between the layers. The surface 1202 of the layer 1204 at the end portion 1212 of the track 1200 is further machined in a vertical direction indicated by direction arrow 1214 plunging a predetermined distance into the layer 1204 along an arc 1220 to provide a localized enlargement 1222 that is arranged so that the end 1224 of the track 1200 is tangential to the arc 1220. A hole 1226 is drilled through the layer 1204 substantially perpendicular to the major face surface 1206 and terminating at the plunged end region 1228 of the track 1200 to create a leak tight sweeping fluid flow transition fluid passageway in the fluid path to help pass any particulate that may be carried by fluid passing in the fluid pathway.

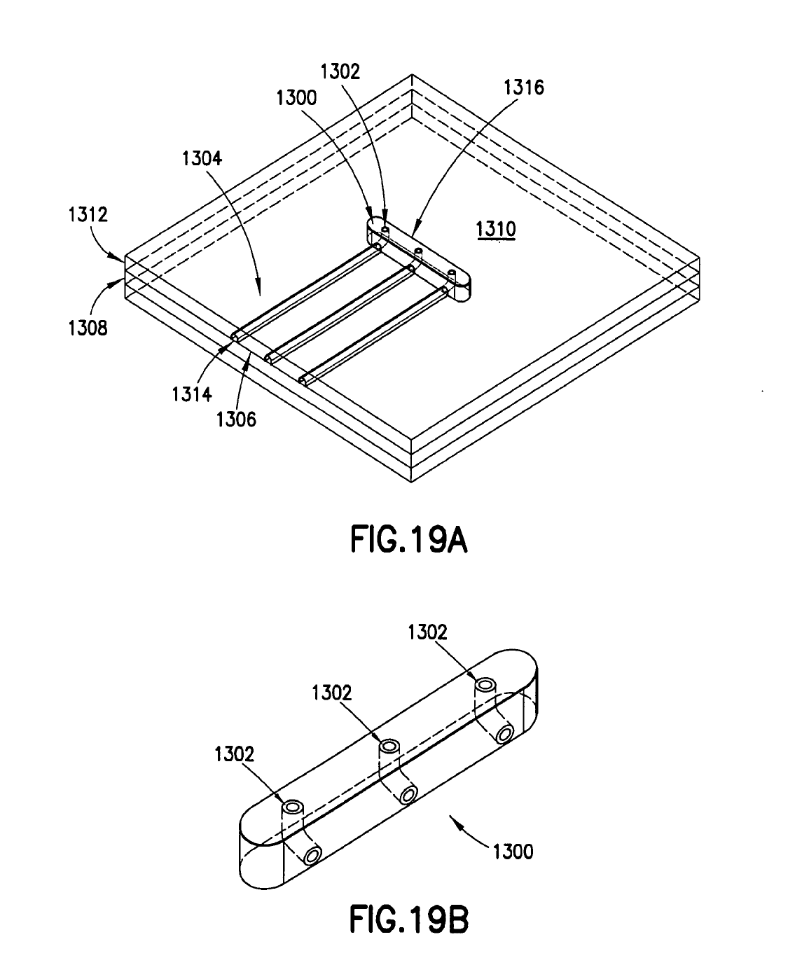

With reference to FIGS. 19A-19B in some embodiments a plug or insert 1300 is preformed by over-molding one or more elbows 1302 to provide a leak tight fluid transition passageway between a fluid pathway 1304 on a major face surface 1306 of a layer 1308 and a component, for example a valve located on an outer major face surface 1310 of an overlying layer 1312 that closes off a groove or track 1314 to form the fluid pathway 1304. An opening for example a cavity or pocket 1316 is arranged to have substantially the same size and shape as the preformed insert or plug 1300 and is machined or milled in the surface 1310 of the overlying layer 1312 and the grooves or tracks 1314 forming the fluid pathways 1304 are positioned in alignment with a respective elbow 1302 to create a leak tight fluid transition passageway when the preformed insert or plug 1300 is inserted in the pocket 1316. The preformed elbow plug 1302 provides a leak tight transition fluid passageway that minimizes back pressure turbulence and fluid friction and is snakeable with a fishline or other wire product to clear or remove potential blockages. In some embodiments the preformed insert is made a permanent and immovable part of the layer by diffusion bonding or chemical bonding or by compressive forces on the insert or by other suitable means to carry out the intended function.

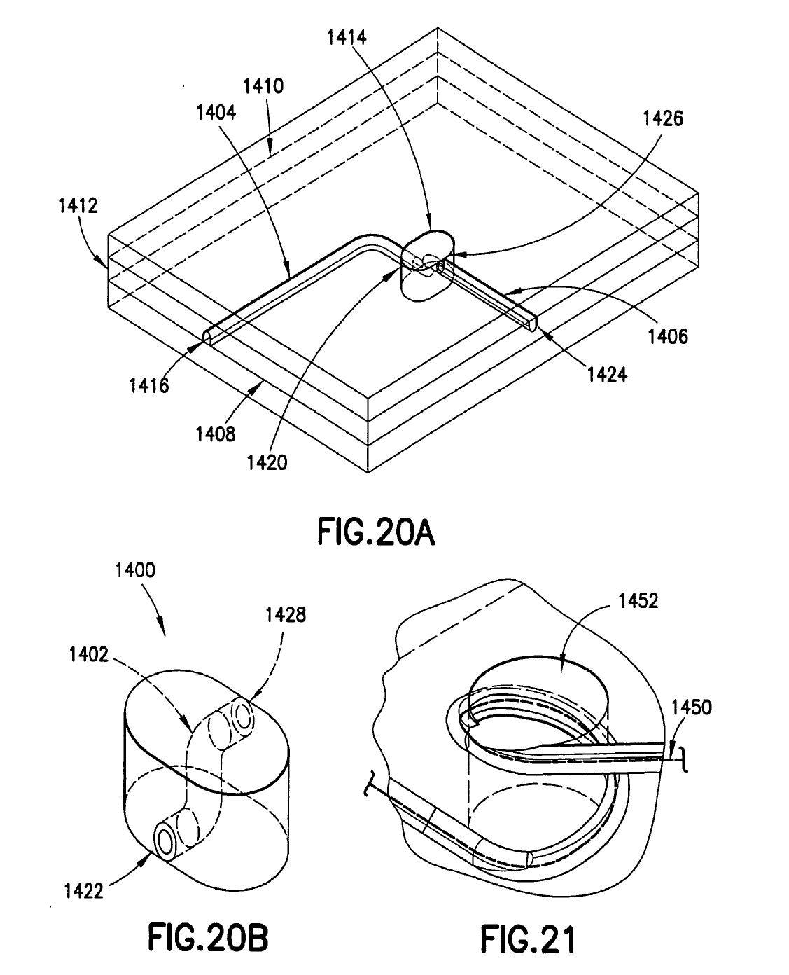

With reference to FIG. 20A-20B in some embodiments a plug or insert 1400 is preformed by over molding an “S”-shaped conduit 1402 to provide a leak tight fluid transition passageway between fluid pathways 1404, 1406 located on oppositely disposed major face surfaces 1408, 1410 respectively of a layer 1412. An opening for example a cavity or pocket 1414 is arranged to have substantially the same size and shape of the plug 1400 and is machined or milled through the layer 1412. A groove or track 1416 is machined or milled in one major face surface of the layer 1412 and terminates at the perimeter 1420 of the pocket 1414 and is aligned with the respective end 1422 of the “S”-shaped conduit 1402 when the plug 1400 is inserted into the pocket 1414. A groove or track 1424 is machined or milled in the oppositely disposed major face surface 1410 of the layer and terminates at the perimeter 1426 of the pocket 1414 and is aligned with the respective opposite end 1428 of the “S”-shaped conduit 1402 when the plug 1400 is inserted into the pocket 1414. The preformed “S”-shaped conduit insert or plug 1400 provides a leak tight transition fluid passageway that minimizes back pressure turbulence and fluid friction and is snakeable with a fish line or other wire product to clear or remove potential blockages. In some embodiments the preformed insert is made a permanent and immovable part of the layer by diffusion bonding or chemical bonding or by compressive forces on the insert or by other suitable means to carry out the intended function.

With reference to FIG. 21 in some embodiments of the invention for example as described herein above, a fishline or other wire product suitable for carryout the intended function generally designated 1450 is shown fed or snaked through a leak tight transition fluid pathway 1452. Because the groove forming the leak tight transition fluid pathway follows a smooth curved path that provides a non-sharp 90° angle turn in the pathway, an end of the fishline is able to travel in the grooved pathway without snagging or catching in the pathway particularly at the directional turns in the pathway. A fishline or other wire product suitable for carrying out the intended function is likewise snakeable thorough the machined leak tight transition fluid pathways as described herein above to clear or remove potential blockages caused by particulate accumulation to the extent that any accumulation occurs.

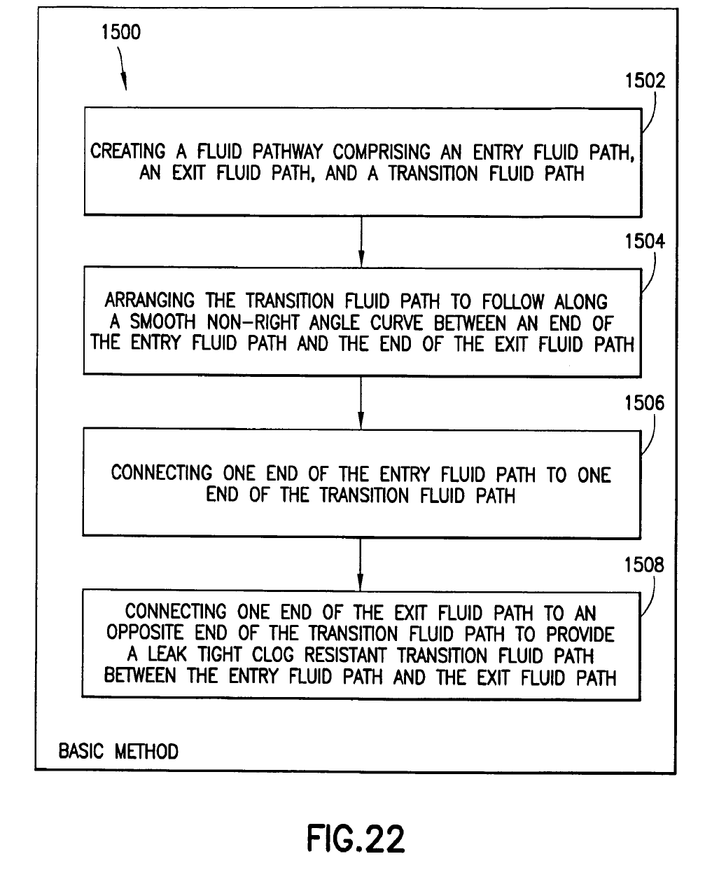

A flowchart showing the basic steps for carrying out an embodiment of the present invention is shown in FIG. 22 and generally designated 1500. The action of creating a fluid pathway comprising an entry fluid path, an exit fluid path and a transition fluid path is shown in step 1502. Next, the action of arranging the transition fluid path to follow along a smooth non-right angle curve between one end of the entry fluid path and an end of the exit fluid path is shown in step 1504. The action of connecting one end of the entry fluid path to one end of the transition fluid path is shown in step 1506. Finally, the action of connecting one end of the exit fluid path to an opposite end of the transition fluid path to provide a leak tight clog resistant transition fluid path between the entry fluid path and the exit fluid path is shown in step 1508.

It is to be understood that the above-described arrangements are only illustrative of the application of the principles of the present invention and are not to be construed as limitations of the invention. Numerous modifications and alternative arrangements may be devised by those skilled in the art without departing from the scope of the invention and the appended claims are intended to cover such modifications and arrangements. Further, the invention contemplates all embodiments that may be inferred directly or indirectly from the disclosure and drawings whether or not expressly stated and claimed. In addition the features shown in the examples of the invention may be combined in various combinations whether or not expressly stated and claimed.

1. A fluidic module, comprising:
a body, comprising:
one or more layers having a width, height and length dimension, a first major face surface and an oppositely disposed second major face surface;
a fluid pathway, comprising:
an entry fluid path;
an exit fluid path;
a transition fluid path arranged and configured to provide a smooth directional turn between said entry fluid path and said exit fluid path.

2. The fluidic module as set forth in claim 1 wherein said transition fluid path comprises an insert having a predefined size and shape configured to be received in a complementary sized and shaped opening in said layer to provide a leak tight communication passageway between said entry fluid path and said exit fluid path.

3. The fluidic module as set forth in claim 2 wherein said transition fluid path comprises a leak tight passageway defined between a surface of said insert in facing relationship with a matching surface of said opening in said layer.

4. The fluidic module as set forth in claim 2 further comprising said entry fluid path arranged on one of said first major face surface and said second major face surface, and said exit fluid path arranged on the other of said first major face surface and said second major face surface.

5. The fluid module as set forth in claim 4 wherein said insert further comprises a cylindrical insert having a cylindrical outer peripheral wall and said opening further comprises a cylindrical opening having a circumferential wall surface wherein said leak tight passageway further comprises a groove inscribed in said cylindrical insert outer peripheral wall along a curved path and closed off by the cylindrical opening circumferential wall surface.

6. The fluidic module as set forth in claim 4 wherein said insert further comprises a cylindrical insert having a cylindrical outer peripheral wall and said opening further comprises a cylindrical opening having a circumferential wall surface wherein said leak tight passageway further comprises a groove inscribed in said cylindrical opening circumferential wall surface along a curved path and is closed off by the cylindrical insert outer peripheral wall surface.

7. The fluidic module as set forth in claim 4 wherein said insert further comprises a cylindrical insert split lengthwise wherein said leak tight passageway further comprises a groove following a curved path inscribed in a lengthwise face surface in at least one split half of the cylindrical insert and closed off by a lengthwise face surface of the other split half of the cylindrical insert.

8. The fluidic module as set forth in claim 7 wherein said leak tight passageway further comprises a groove following a curved path inscribed in the lengthwise face surface in one split half of the cylindrical insert and closed off by a mirror image groove inscribed in the lengthwise face surface of the other split half of the cylindrical insert.

9. The fluidic module as set forth in claim 4 wherein said insert further comprises a cylindrical insert configured with at least one fluid conduit extending through said cylindrical insert between points on the circumferential wall surface to provide said leak tight passageway at a desired angle between said entry fluid path and said exit fluid path.

10. The fluidic module as set forth in claim 4 wherein said insert further comprises a stack of cylindrical inserts made up of any number of cylindrical inserts comprising an angled fluid path cylindrical insert, a straight fluid path cylindrical insert and rotatable with respect to one another to provide said leak tight passageway between said entry fluid path and said exit fluid path.

11. The fluidic module as set forth in claim 10 wherein said angled fluid path cylindrical insert and said straight fluid path cylindrical insert are configured with castellations for cooperative engagement with castellations on an adjacent angled fluid path cylindrical insert and a straight fluid path cylindrical insert to maintain a relative alignment of said cylindrical inserts comprising said stack.

12. The fluidic module as set forth in claim 3 further comprising:
one of said entry fluid path and said exit fluid path configured to lie in a first plane of a layer and the other of said entry fluid path and said exit fluid path configured to be in a direction substantially perpendicular to said first plane of the layer;
a cavity having an outer facing shoulder surface, one end of said entry fluid path arranged to terminate at one side of the outer facing shoulder surface and one end of said exit fluid path arranged to terminate at an end opposite the one side of the outer facing shoulder surface;
said insert configured to provide an inner facing “ski jump” curved surface mirroring said cavity outer facing shoulder surface wherein said leak tight passageway further comprises a groove inscribed in said insert inner facing “ski jump” curved surface and closed off by said cavity shoulder surface.

13. The fluidic module as set forth in claim 12 wherein said leak tight passageway further comprises a groove inscribed in said cavity shoulder surface mirroring said groove inscribed in said insert inner facing “ski jump” curved surface.

14. The fluidic module as set forth in claim 3 further comprising:
one of said entry fluid path and said exit fluid path configured to lie in a first plane of a layer and the other of said entry fluid path and said exit fluid path configured to be in a direction substantially perpendicular to said first plane of the layer;
a cavity having an outer facing concave surface, one end of said entry fluid path arranged to terminate at one side of the outer facing concave surface and one end of said exit fluid path arranged to terminate at an end opposite the one side of the outer facing concave surface;
said insert configured to provide an inner facing “ski jump” convex surface mirroring said cavity outer facing concave surface wherein said leak tight passageway further comprises a groove inscribed in said insert inner facing “ski jump” convex surface and closed off by said cavity outer facing concave surface.

15. The fluidic module as set forth in claim 14 wherein said leak tight passageway further comprises a groove inscribed in said cavity outer facing concave surface mirroring said groove inscribed in said insert inner facing “ski jump” convex surface.

16. The fluidic module as set forth in claim 3 further comprising:
one of said entry fluid path and said exit fluid path configured to lie in a first plane of a layer and the other of said entry fluid path and said exit fluid path configured to be in a direction substantially perpendicular to said first plane of the layer;
a cavity, one end of said entry fluid path arranged to terminate at a desired location along a peripheral wall of said cavity and one end of said exit fluid path arranged to terminate at said desired location along said peripheral wall of said cavity in a direction substantially perpendicular to said one end of said entry fluid;
said insert arranged with an inner facing curved elbow surface in communication with said one end of said entry fluid path and said one end of said exit fluid path to provide said leak tight passageway between said entry fluid path and said exit fluid path.

17. The fluidic module as set forth in claim 1 further comprising:
said entry fluid path arranged at a first desired angle between said first major face surface and said second major face surface of a first layer;
said exit fluid path arranged at a second desired angle between said first major face surface and said second major face surface of a second layer;
said transition fluid path further comprising a hole through a third layer sandwiched between said first layer and said third layer and configured to intersect between one end of said entry fluid path and one end of said exit fluid path to provide a leak tight communication passageway at a desired angle between said entry fluid path and said exit fluid path.

18. The fluidic module as set forth in claim 1 wherein said transition fluid path further comprises a one end of said exit fluid path configured as a funnel and arranged normal to and in intersecting contact with a one end of said entry fluid path to provide a leak tight communication between said entry fluid path and said exit fluid path.

19. The fluidic module as set forth in claim 4 wherein said insert further comprises a cylindrical insert having a cylindrical outer peripheral wall and a groove inscribed in said cylindrical insert outer peripheral wall along a curved path and said opening further comprises a cylindrical opening having a circumferential wall surface and a groove mirroring the groove inscribed in the cylindrical insert outer peripheral wall inscribed in said cylindrical opening circumferential wall surface wherein said groove in said cylindrical insert and said groove in said cylindrical opening close off one another to create said leak tight passageway.

20. Method, comprising:
creating a fluid pathway comprising:
an entry fluid path,;
an exit fluid path, and
a transition fluid path;
arranging the transition fluid path to follow along a smooth curve between an end of the entry fluid path and the end of the exit fluid path;
connecting one end of the entry fluid path to one end of the transition fluid path;
connecting one end of the exit fluid path to an opposite end of the transition fluid path to provide a leak tight clog resistant transition fluid path between the entry fluid path and the exit fluid path.

21. The method as set forth in claim 20 further comprising:
creating the leak tight transition fluid path between an outer facing surface of an insert and an oppositely disposed matching face surface of an opening configured to receive the insert;
forming a groove in at least one of the outer facing surface of the insert and the oppositely disposed matching face surface of the opening;
receiving the insert in the opening;
closing off the groove with the at least one of the outer facing surface of the insert and the oppositely disposed matching face surface of the opening when the insert is received in the opening to form the leak tight transition fluid path between the entry fluid path and the exit fluid path.

22. An apparatus, comprising:
means for providing a body comprising one or more layers having a width, height and length dimension, a first major face surface and an oppositely disposed second major face surface;
means for providing a fluid pathway comprising an entry fluid path and an exit fluid path, and
means for providing a transition fluid path arranged and configured to provide a smooth directional turn between said entry fluid path and said exit fluid path.

23. The apparatus as set forth in claim 22 further comprising:
means for providing an insert having a predefined size and shape configured to be received in a complementary sized and shaped opening in said layer to provide a leak tight communication passageway between said entry fluid path and said exit fluid path.

24. An insert for use in a fluidic manifold, comprising:
a plug having a predefined size and shape and configured to be received in a complementary sized and shaped opening in a layer of the fluidic manifold, and
a groove inscribed in a peripheral wall surface of the plug and following along a smooth curved path and defining a transition fluid path between the peripheral wall surface of the plug and a facing surface of the opening when the plug is received in the opening in the layer of the fluidic manifold.

25. The insert as set forth in claim 24 further comprising a cylindrical plug and said groove following a spiral path along the circumferential peripheral wall surface of the plug.

26. The insert as set forth in claim 24 further comprising a “ski jump” plug.

27. The insert as set forth in claim 24 further comprising an elbow plug.

28. The insert as set forth in claim 24 further comprising a pillow-like plug.

29. The insert as set forth in claim 24 further comprising a split plug.
